(19) United States
(12) Patent Application Publication
(10) Pub. No.: US 2023/0308773 A1
(43) Pub. Date: Sep. 28, 2023

(54) INFORMATION PROCESSING APPARATUS AND CORRECTION PROCESSING METHOD

(71) Applicant: Fujitsu Limited, Kawasaki-shi (JP)

(72) Inventor: Toshiyuki ICHIBA, Kawasaki (JP)

(73) Assignee: Fujitsu Limited, Kawasaki-shi (JP)

(21) Appl. No.: 18/063,701

(22) Filed: Dec. 9, 2022

(30) Foreign Application Priority Data
Mar. 2, 2022 (JP) 2022-032192

(51) Int. Cl. H04N 23/81; G06T 5/00

(52) U.S. Cl. CPC H04N 23/81; G06T 5/006

(57) ABSTRACT

An information processing apparatus includes: a memory configured to store correction information for performing distortion correction on an image; and a processor coupled to the memory and configured to: based on a characteristic of each imaging circuit of a plurality of imaging circuits that captures different images, group two or more imaging circuits for each of which determination is made that distortion correction is capable of being performed on an image based on the correction information among the plurality of imaging circuits; and perform distortion correction on an image captured by each imaging circuit of the two or more imaging circuits that are grouped, based on the correction information stored in the memory.

### CROSS-REFERENCE TO RELATED APPLICATION

This application is based upon and claims the benefit of priority of the prior Japanese Patent Application No. 2022-32192, filed on Mar. 2, 2022, the entire contents of which are incorporated herein by reference.

### FIELD

The embodiment discussed herein is related to an information processing apparatus, a correction processing method, and a computer-readable recording medium storing a correction processing program.

### BACKGROUND

In related art, there is a technique of performing distortion correction on an image captured by a camera. For example, distortion correction is performed on an image captured by each camera of a plurality of cameras by referring to a main storage device that stores, in association with each camera, a remap table that enables distortion correction to be performed on an image captured by the camera.

Japanese Laid-open Patent Publication No. 2001-92949, Japanese National Publication of International Patent Application No. 2013-187630, U.S. Patent Application Publication No. 2020/0204728, and U.S. Patent No. 6430313 are disclosed as related art.

### SUMMARY

According to an aspect of the embodiments, an information processing apparatus includes: a memory configured to store correction information for performing distortion correction on an image; and a processor coupled to the memory and configured to: based on a characteristic of each imaging circuit of a plurality of imaging circuits that captures different images, group two or more imaging circuits for each of which determination is made that distortion correction is capable of being performed on an image based on the correction information among the plurality of imaging circuits; and perform distortion correction on an image captured by each imaging circuit of the two or more imaging circuits that are grouped, based on the correction information stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an exemplary embodiment of a correction processing method according to an embodiment;

FIG. 2 is an explanatory diagram illustrating an example of an information processing system;

FIG. 3 is a block diagram illustrating an example of the hardware configuration of an information processing apparatus;

FIG. 4 is a block diagram illustrating an example of the hardware configuration of an image capturing device;

FIG. 5 is a block diagram illustrating an example of the functional configuration of the information processing apparatus;

FIG. 6 is an explanatory diagram illustrating the details of remap processing;

FIG. 7 is an explanatory diagram illustrating a specific example of correction parameters;

FIG. 8 is an explanatory diagram illustrating an example of a situation in which distortion correction is performed;

FIG. 9 is an explanatory diagram illustrating an example of a management table and a remap table;

FIG. 10 is an explanatory diagram illustrating operation example 1 of the information processing apparatus;

FIG. 11 is an explanatory diagram illustrating an example of an effect produced by the information processing apparatus;

FIG. 12 is a flowchart illustrating an example of an overall processing procedure in operation example 1;

FIG. 13 is an explanatory diagram illustrating an example of image processing;

FIG. 14 is an explanatory diagram illustrating operation example 2 of the information processing apparatus;

FIG. 15 is an explanatory diagram illustrating an example of estimating a remap table;

FIG. 16 is a flowchart illustrating an example of an overall processing procedure in operation example 2;

FIG. 17 is an explanatory diagram illustrating the relationship between correction parameters;

FIG. 18 is an explanatory diagram illustrating operation example 3 of the information processing apparatus;

FIG. 19 is a flowchart illustrating an example of an overall processing procedure in operation example 3;

FIG. 20 is an explanatory diagram illustrating an example of a reference table and a difference table;

FIG. 21 is an explanatory diagram illustrating operation example 4 of the information processing apparatus; and

FIG. 22 is a flowchart illustrating an example of an overall processing procedure in operation example 4.

### DESCRIPTION OF EMBODIMENTS

As related art, for example, there is a technique in which image processing is performed in parallel on input image data of a plurality of input registers. For example, there is a technique in which reference parameters to be referred to are selected in advance and stored in a reference parameter table memory so that reference parameters to be referred to may be reduced according to the area of a frame. For example, there is a technique of calculating a plurality of difference parameters of characteristic values for two sets of image data at a time, accumulating the difference parameters within a predetermined time, and determining a plurality of weighting values corresponding to pixels in accordance with the accumulated difference parameters. For example, there is a technique of storing parameters obtained by modeling fluctuations in an integrated circuit (IC) manufacturing process used for manufacturing a color image sensor, the number of parameters being smaller than the number of elements included in one of sensor-specific correction matrices.

However, in related art, there is a problem that an increase in band usage for a main storage device is caused. For example, there is a problem that, when there is a plurality of cameras, remap tables corresponding to the respective cameras are read from a main storage device, and as the number of cameras increases, the band usage for the main storage device increases. For this reason, the processing time taken to perform distortion correction on an image captured by a camera tends to increase.

In one aspect, an object of the present disclosure is to achieve reduction in band usage.

Hereinafter, an embodiment of an information processing apparatus, a correction processing method, and a correction processing program according to the present disclosure will be described in detail with reference to the drawings.

### Exemplary Embodiment of Correction Processing Method According to Embodiment

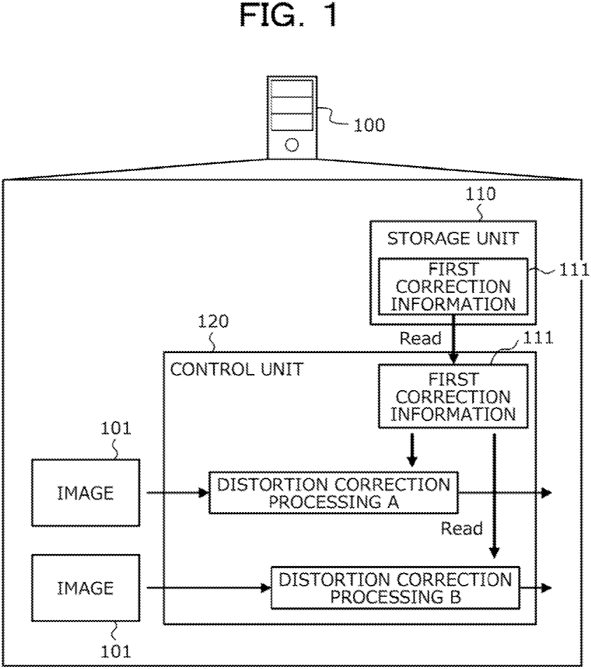

FIG. 1 is an explanatory diagram illustrating an exemplary embodiment of the correction processing method according to the embodiment. An information processing apparatus 100 is a computer that performs distortion correction on an image.

In related art, distortion correction is performed on an image captured by a camera. Distortion correction is achieved by remapping of an image. Remapping is processing of generating an image after distortion correction by setting pixel information included in an image before distortion correction to pixel information of a specific position included in the image after distortion correction.

For example, distortion correction is performed on an image captured by a camera based on a remap table that enables the distortion correction to be performed on the image captured by a camera. A remap table is correction information indicating the correspondence relationship between the position of each piece of pixel information included in an image before distortion correction and the position of pixel information included in an image after distortion correction corresponding to the position of each piece of pixel information included in the image before distortion correction. For example, a remap table corresponds to a characteristic of a camera. A remap table enables distortion correction to be performed by making generable an image after distortion correction from an image before distortion correction based on the correspondence relationship.

For example, there is a case in which a camera continuously captures images. For example, a camera is a monitoring camera that continuously captures images of any point. In this case, for example, every time an image is captured by a camera, distortion correction is performed on the image in real time.

The amount of data of an image tends to increase, and reduction in the processing time taken to perform distortion correction is desired. For this reason, for example, there is a case in which distortion correction is performed by a field-programmable gate array (FPGA).

The built-in memory of an FPGA tends to have a relatively small storage capacity. For example, a built-in memory is also referred to as an on-chip memory. For example, a built-in memory is about 30 megabytes (MB). On the other hand, a main storage device outside an FPGA tends to have a relatively large storage capacity. For example, a main storage device is also referred to as an off-chip memory. For example, a main storage device is about 32 gigabytes (GB).

Accordingly, it is conceivable to suppress the shortage of a built-in memory by preparing, in the built-in memory, a line buffer for reading each part of an image. Since the amount of data of a remap table that enables distortion correction to be performed on an image increases as the size of the image increases, a remap table tends to be stored in a main storage device.

However, there is a problem that an increase in band usage for a main storage device is caused. For this reason, the processing time taken for an FPGA to perform distortion correction on an image captured by a camera may increase. For example, as the amount of data of a remap table increases, the band usage for a main storage device increases. For example, an FPGA may not read a remap table at one time, and the processing time taken to perform distortion correction on an image captured by a camera may increase.

Alternatively, a method is conceivable in which an FPGA reads a part of a remap table and estimates the remap table, thereby performing distortion correction on an image captured by a camera based on the estimated remap table. Even with this method, there are cases in which it is difficult to suppress an increase in band usage for a main storage device.

For example, there is a case in which there is a plurality of cameras. In this case, distortion correction is performed on an image captured by each camera of the plurality of cameras. For example, an FPGA performs distortion correction on an image captured by each camera based on a remap table that enables distortion correction to be performed on an image captured by each camera.

Since the number of remap tables read from a main storage device increases as the number of cameras increases, the band usage for the main storage device increases. Similarly, it is considered that the shortage of a built-in memory easily occurs as the number of cameras increases. As the number of cameras increases, the number of images on which distortion correction is performed increases.

For this reason, the processing time taken for an FPGA to perform distortion correction on an image captured by a camera tends to increase. As a result, even if an FPGA attempts to perform distortion correction on an image each time an image is captured by a camera, distortion correction on the current image may not be completely performed by the time when the next image is captured.

Accordingly, in the present embodiment, the correction processing method capable of achieving reduction in band usage will be described.

In FIG. 1, there is a plurality of imaging units that captures different images 101. In the example of FIG. 1, there are two imaging units. For example, an imaging unit is a camera. It is desired that the information processing apparatus 100 performs distortion correction on the image 101 captured by each camera.

The information processing apparatus 100 includes a storage unit 110. The storage unit 110 identifiably stores correction information that enables distortion correction to be performed on the image 101. For example, the storage unit 110 stores correction information itself that enables distortion correction to be performed on the image 101. For example, correction information is a remap table. For example, the storage unit 110 stores, in association with the characteristic that an imaging unit may have, correction information that enables distortion correction to be performed on the image 101 captured by an imaging unit having the characteristic. For example, the storage unit 110 is a main storage device.

The information processing apparatus 100 includes a control unit 120. For example, the control unit 120 is realized by using an FPGA. The control unit 120 includes a built-in memory. For example, the built-in memory includes a buffer. For example, the image 101 is temporarily stored in the buffer. For example, correction information is temporarily stored in the buffer.

(1-1) The information processing apparatus 100 causes the control unit 120 to group two or more imaging units for each of which it is determined that distortion correction may be performed on the image 101 based on first correction information 111 among a plurality of imaging units, based on the characteristic of each imaging unit. For example, the information processing apparatus 100 groups two or more imaging units having the same characteristic corresponding to the first correction information 111 stored in the storage unit 110 based on the characteristic of each imaging unit.

(1-2) The information processing apparatus 100 causes the control unit 120 to perform distortion correction on the image 101 captured by each imaging unit of the two or more grouped imaging units, based on the first correction information 111 identified from the storage contents of the storage unit 110. For example, the information processing apparatus 100 identifies the first correction information 111 stored in the storage unit 110 in association with the same characteristic of the two or more grouped imaging units, and reads the first correction information from the storage unit 110. For example, the information processing apparatus 100 performs distortion correction on the image 101 captured by each imaging unit of the two or more grouped imaging units, based on the read first correction information 111.

For example, the information processing apparatus 100 performs distortion correction processing A on the image 101 captured by one imaging unit of the two or more grouped imaging units, based on the read first correction information 111. For example, the information processing apparatus 100 performs distortion correction processing B on the image 101 captured by the other imaging unit of the two or more grouped imaging units, based on the read first correction information 111.

Accordingly, the information processing apparatus 100 may achieve reduction in band usage of the storage unit 110. The information processing apparatus 100 may achieve reduction in the usage of the built-in memory of the control unit 120, and may suppress the shortage of the built-in memory. For this reason, the information processing apparatus 100 may suppress an increase in the processing time taken to perform distortion correction on the plurality of images 101.

Although a case has been described in which the storage unit 110 stores correction information itself that enables distortion correction to be performed on the image 101, this is not the only case. For example, there may be a case in which the storage unit 110 stores a parameter or the like that makes correction information that enables distortion correction to be performed on the image 101 identifiable.

Although a case has been described in which the first correction information 111 is already stored in the storage unit 110, this is not the only case. Although a case has been described in which the information processing apparatus 100 groups two or more imaging units for each of which it is determined that distortion correction may be performed on the image 101 based on the first correction information 111, this is not the only case. For example, there may be a case in which, after grouping two or more imaging units for each of which it is determined that distortion correction may be performed on the image 101 based on the same correction information, the information processing apparatus 100 generates the correction information. In this case, the information processing apparatus 100 stores the generated correction information in the storage unit 110 as the first correction information 111.

Although a case has been described in which the information processing apparatus 100 operates alone, this is not the only case. For example, there may be a case in which a plurality of computers implements the function of the information processing apparatus 100 by cooperating with each other.

### (Example of Information Processing System 200)

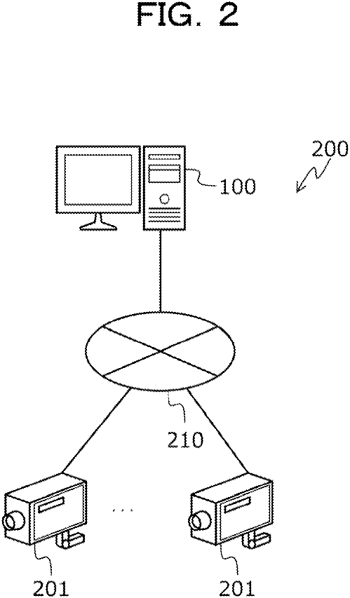

Next, an example of an information processing system 200 in which the information processing apparatus 100 illustrated in FIG. 1 is applied will be described with reference to FIG. 2.

FIG. 2 is an explanatory diagram illustrating an example of the information processing system 200. In FIG. 2, the information processing system 200 includes the information processing apparatus 100 and a plurality of image capturing devices 201.

In the information processing system 200, the information processing apparatus 100 and the image capturing devices 201 are coupled to each other via a wired or wireless network 210. For example, the network 210 is a local area network (LAN), a wide area network (WAN), the Internet, or the like.

The information processing apparatus 100 is a computer that performs distortion correction on an image. The information processing apparatus 100 includes an FPGA. The information processing apparatus 100 identifiably stores correction information that enables distortion correction to be performed on an image. For example, the information processing apparatus 100 stores, in association with each model number that the image capturing device 201 may have, correction information that enables distortion correction to be performed on an image captured by the image capturing device 201. The information processing apparatus 100 receives, from each image capturing device 201, an image captured by the image capturing device 201.

The information processing apparatus 100 groups the image capturing devices 201 based on the characteristic of each image capturing device 201. For example, the characteristic is the attribute of the image capturing device 201. For example, the attribute is a model number or the like. For example, the characteristic may be the attribute of a lens of a camera included in the image capturing device 201. For example, the characteristic may be the attribute of an image captured by the image capturing device 201. For example, the attribute is a resolution, a size, or the like. For example, the information processing apparatus 100 groups two or more image capturing devices 201 having the same model number among the plurality of image capturing devices 201.

The information processing apparatus 100 rewrites an FPGA so as to perform distortion correction on an image captured by each image capturing device 201 of the two or more grouped image capturing devices 201. The information processing apparatus 100 causes an FPGA to perform distortion correction on an image captured by each image capturing device 201 of the two or more grouped image capturing devices 201.

For example, the information processing apparatus 100 causes the FPGA to read correction information corresponding to the same model number of the two or more grouped image capturing devices 201. For example, the information processing apparatus 100 causes the FPGA to perform distortion correction on an image captured by each image capturing device 201 of the two or more grouped image capturing devices 201 based on the read correction information.

The information processing apparatus 100 causes the FPGA to output an image on which distortion correction has been performed. For example, the output form is display on a display, output to a printer for printing, transmission to another computer, storage in a storage area, or the like. For example, the information processing apparatus 100 is a server, a personal computer (PC), or the like.

The image capturing device 201 is a computer that captures an image. The image capturing device 201 transmits a captured image to the information processing apparatus 100. The image capturing device 201 may transmit the model number or the like of the own device to the information processing apparatus 100 together with the captured image. For example, the image capturing device 201 is a monitoring camera or the like. For example, the image capturing device 201 may be a smartphone or the like.

Although a case has been described in which the information processing apparatus 100 is an apparatus different from the image capturing device 201, this is not the only case. For example, there may be a case in which the information processing apparatus 100 has the function of the image capturing device 201 and also operates as the image capturing device 201.

### (Example of Hardware Configuration of Information Processing Apparatus 100)

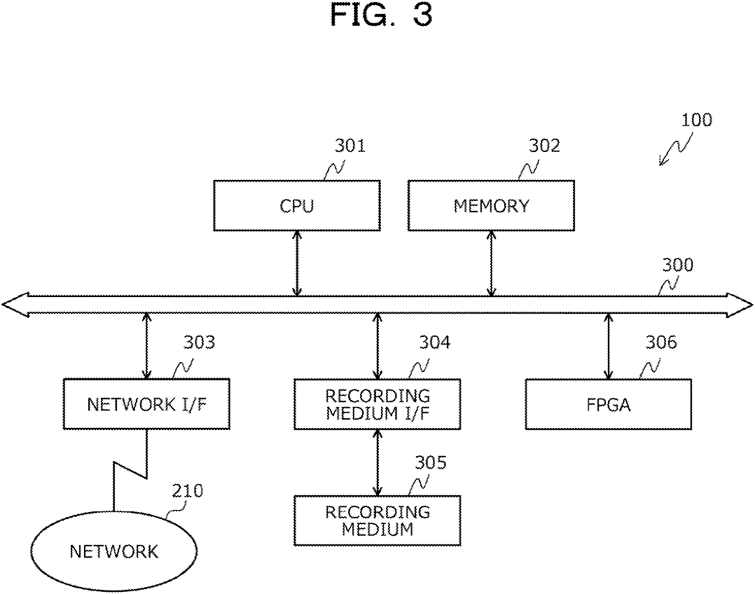

Next, an example of the hardware configuration of the information processing apparatus 100 will be described with reference to FIG. 3.

FIG. 3 is a block diagram illustrating an example of the hardware configuration of the information processing apparatus 100. In FIG. 3, the information processing apparatus 100 includes a central processing unit (CPU) 301, a memory 302, a network interface (I/F) 303, a recording medium I/F 304, a recording medium 305, and an FPGA 306. The components are coupled to each other through a bus 300.

The CPU 301 controls the entire information processing apparatus 100. For example, the memory 302 includes a read-only memory (ROM), a random-access memory (RAM), a flash ROM, and the like. For example, the RAM is a dynamic RAM (DRAM).

For example, the flash ROM and the ROM store various programs, and the RAM is used as a work area for the CPU 301. The CPU 301 is caused to execute the processing coded in the programs stored in the memory 302 by the CPU 301 loading the programs.

The network I/F 303 is coupled to the network 210 through a communication line, and is coupled to another computer via the network 210. The network I/F 303 serves as an interface between the network 210 and the internal components, and controls input and output of data from and to the other computer. For example, the network I/F 303 is a modem, a LAN adapter, or the like.

The recording medium I/F 304 controls reading and writing of data from and to the recording medium 305 in accordance with the control of the CPU 301. For example, the recording medium I/F 304 is a disk drive, a solid-state drive (SSD), a Universal Serial Bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may be removably attached to the information processing apparatus 100.

The FPGA 306 is an arithmetic circuit that may dynamically change the details of processing. The FPGA 306 includes a static RAM (SRAM). The FPGA 306 may access the memory 302. For example, the FPGA 306 may access the DRAM included in the memory 302.

In addition to the components described above, for example, the information processing apparatus 100 may include a keyboard, a mouse, a display, a printer, a scanner, a microphone, a speaker, and the like. The information processing apparatus 100 may include a plurality of recording medium I/Fs 304 and a plurality of recording media 305. The information processing apparatus 100 does not have to include the recording medium I/F 304 and the recording medium 305.

### (Example of Hardware Configuration of Image Capturing Device 201)

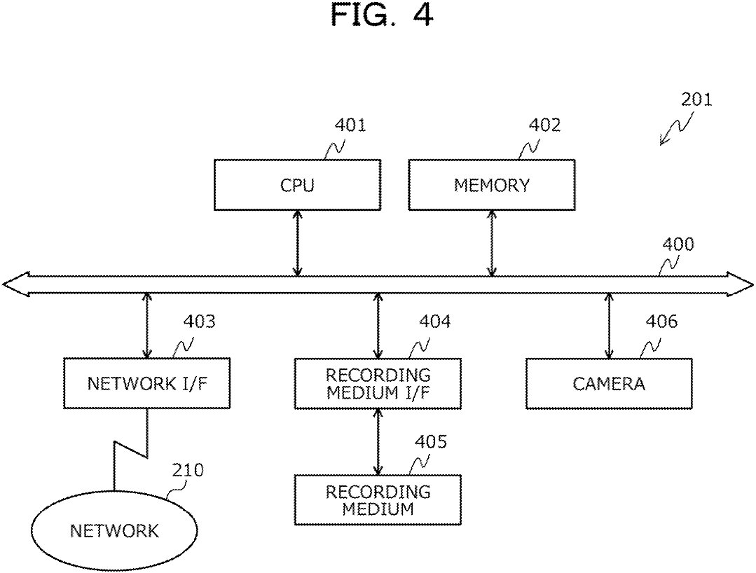

Next, an example of the hardware configuration of the image capturing device 201 will be described with reference to FIG. 4.

FIG. 4 is a block diagram illustrating an example of the hardware configuration of the image capturing device 201. In FIG. 4, the image capturing device 201 includes a CPU 401, a memory 402, a network I/F 403, a recording medium I/F 404, a recording medium 405, and a camera 406. The components are coupled to each other through a bus 400.

The CPU 401 controls the entire image capturing device 201. For example, the memory 402 includes a ROM, a RAM, a flash ROM, and the like. For example, the flash ROM and the ROM store various programs, and the RAM is used as a work area for the CPU 401. The CPU 401 is caused to execute the processing coded in the programs stored in the memory 402 by the CPU 401 loading the programs.

The network I/F 403 is coupled to the network 210 through a communication line, and is coupled to another computer via the network 210. The network I/F 403 serves as an interface between the network 210 and the internal components, and controls input and output of data from and to the other computer. For example, the network I/F 403 is a modem, a LAN adapter, or the like.

The recording medium I/F 404 controls reading and writing of data from and to the recording medium 405 in accordance with the control of the CPU 401. For example, the recording medium I/F 404 is a disk drive, an SSD, a USB port, or the like. The recording medium 405 is a nonvolatile memory that stores data written under the control of the recording medium I/F 404. For example, the recording medium 405 is a disk, a semiconductor memory, a USB memory, or the like. The recording medium 405 may be removably attached to the image capturing device 201. The camera 406 includes a plurality of imaging elements and captures an image by the plurality of imaging elements. For example, the camera 406 is a monitoring camera.

In addition to the components described above, for example, the image capturing device 201 may include a keyboard, a mouse, a display, a printer, a scanner, a microphone, a speaker, and the like. The image capturing device 201 may include a plurality of recording medium I/Fs 404 and a plurality of recording media 405. The image capturing device 201 does not have to include the recording medium I/F 404 and the recording medium 405.

### (Example of Functional Configuration of Information Processing Apparatus 100)

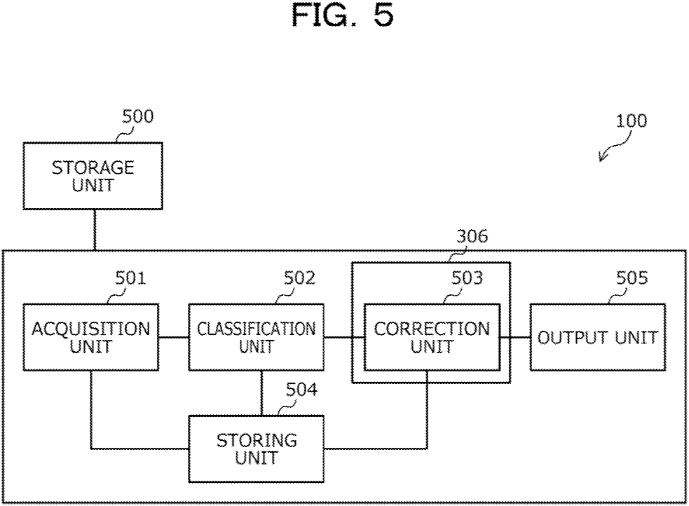

Next, an example of the functional configuration of the information processing apparatus 100 will be described with reference to FIG. 5.

FIG. 5 is a block diagram illustrating an example of the functional configuration of the information processing apparatus 100. The information processing apparatus 100 includes a storage unit 500, an acquisition unit 501, a classification unit 502, a correction unit 503, a storing unit 504, and an output unit 505.

For example, the storage unit 500 is realized by a storage area such as the memory 302 or the recording medium 305 illustrated in FIG. 3. For example, the storage unit 500 is realized by the storage area of the DRAM included in the memory 302. Although a case will be described below in which the storage unit 500 is included in the information processing apparatus 100, this is not the only case. For example, there may be a case in which the storage unit 500 is included in an apparatus different from the information processing apparatus 100 and the storage contents of the storage unit 500 may be referred to from the information processing apparatus 100.

The acquisition unit 501 to the output unit 505 function as an example of the control unit. For example, the acquisition unit 501 to the output unit 505 implement their functions by causing the CPU 301 to execute a program stored in a storage area such as the memory 302 or the recording medium 305 illustrated in FIG. 3 or by using the network I/F 303. For example, at least the correction unit 503 may implement its function by the FPGA 306. For example, a processing result of each functional unit is stored in a storage area such as the memory 302 or the recording medium 305 illustrated in FIG. 3.

The storage unit 500 stores various kinds of information to be updated or referred to in the processing of each functional unit. For example, the storage unit 500 identifiably stores correction information that enables distortion correction to be performed on an image. An image is captured by an imaging unit. For example, the imaging unit is the image capturing device 201. For example, the imaging unit is the camera 406 included in the image capturing device 201. For example, enabling distortion correction to be performed means that an image after distortion correction may be generated from an image before distortion correction.

For example, the storage unit 500 stores correction information itself that enables distortion correction to be performed on an image. For example, the storage unit 500 stores first correction information that enables distortion correction to be performed on an image captured by each imaging unit of two or more imaging units. For example, the storage unit 500 may store a parameter that makes identifiable correction information that enables distortion correction to be performed on an image. For example, identifiable means that a value forming correction information may be calculated from the parameter.

For example, the first correction information is correction information that enables distortion correction to be directly performed on an image captured by each imaging unit of the two or more imaging units. For example, the first correction information may be correction information that enables distortion correction to be indirectly performed on an image captured by each imaging unit of the two or more imaging units. For example, the first correction information may be original correction information that makes identifiable other correction information that enables distortion correction to be directly performed on an image captured by each imaging unit of the two or more imaging units. For example, identifiable means that other correction information may be generated from the original correction information.

For example, the storage unit 500 may store difference information between each piece of correction information and reference correction information so as to make identifiable each piece of correction information of a plurality of pieces of correction information that enables distortion correction to be performed on different images. For example, reference correction information is generable from specific parameters. For example, the correction unit 503 may have the specific parameters. For example, generable means that a value forming correction information may be calculated from the parameter.

The acquisition unit 501 acquires various kinds of information to be used for the processing of each functional unit. The acquisition unit 501 stores the acquired various kinds of information in the storage unit 500 or outputs the information to each functional unit. The acquisition unit 501 may output the various kinds of information stored in the storage unit 500 to each functional unit. For example, the acquisition unit 501 acquires various kinds of information based on an operation input by a user. For example, the acquisition unit 501 may receive various kinds of information from an apparatus different from the information processing apparatus 100.

The acquisition unit 501 acquires an image captured by an imaging unit. For example, the acquisition unit 501 acquires an image captured by an imaging unit by receiving the image from the imaging unit.

The acquisition unit 501 may acquire the characteristic of an imaging unit. For example, the characteristic is the attribute or the like of the imaging unit. For example, the acquisition unit 501 acquires the attribute of the imaging unit as the characteristic of the imaging unit. For example, the attribute is a model number or the like. For example, the acquisition unit 501 acquires the attribute of a lens included in the imaging unit as the characteristic of the imaging unit. For example, the attribute is a curvature or the like. For example, the acquisition unit 501 acquires, as the characteristic of the imaging unit, the attribute of an image captured by the imaging unit, together with the image. For example, the attribute is a parameter related to an image. For example, the attribute is a resolution, a size, or the like.

The acquisition unit 501 may accept a start trigger for starting the processing of any functional unit. For example, the start trigger is a predetermined operation input by a user. For example, the start trigger may be reception of predetermined information from another computer. For example, the start trigger may be an output of predetermined information from any functional unit.

For example, the acquisition unit 501 accepts the acquisition of an image as a start trigger for starting the processing of the correction unit 503. For example, the acquisition unit 501 may accept the acquisition of a characteristic as a start trigger for starting the processing of the classification unit 502.

The classification unit 502 groups imaging units. For example, based on the characteristic of each imaging unit, the classification unit 502 groups two or more imaging units for each of which it is determined that distortion correction may be performed on an image based on the same correction information among a plurality of imaging units. The same correction information is any piece of correction information stored in the storage unit 500.

For example, the classification unit 502 groups two or more imaging units having the same characteristic by determining that distortion correction may be directly performed on an image based on first correction information. Accordingly, the classification unit 502 may identify a group of two or more imaging units in which the processing of reading correction information from the storage unit 500 may be commonized.

For example, the classification unit 502 groups two or more imaging units based on the attribute of the imaging unit acquired from each imaging unit. For example, the classification unit 502 groups two or more imaging units having the same or similar attributes by determining that distortion correction may be directly performed on an image based on the same first correction information. Accordingly, the classification unit 502 may identify a group of two or more imaging units in which the processing of reading correction information from the storage unit 500 may be commonized.

For example, the classification unit 502 groups two or more imaging units based on the attribute of an image acquired from each imaging unit, the image being captured by the imaging unit. For example, the classification unit 502 groups two or more imaging units that capture different images having the same or similar attributes by determining that distortion correction may be directly performed on the images based on the same first correction information. Accordingly, the classification unit 502 may identify a group of two or more imaging units in which the processing of reading correction information from the storage unit 500 may be commonized.

For example, the classification unit 502 may group two or more imaging units for each of which it is determined that distortion correction may be indirectly performed on an image based on the same correction information among a plurality of imaging units. For example, the classification unit 502 groups two or more imaging units for each of which it is determined that distortion correction may be performed on an image based on correction information that is similar to the same correction information among the plurality of imaging units. For example, correction information similar to the same correction information is correction information included in two or more pieces of correction information generable from the same correction information.

For example, the classification unit 502 groups two or more imaging units having the same or similar attributes by determining that distortion correction may be performed on an image based on correction information that is similar to the same correction information. Accordingly, the classification unit 502 may identify a group of two or more imaging units in which the processing of reading correction information from the storage unit 500 may be commonized.

For example, the classification unit 502 groups two or more imaging units that capture different images having the same or similar attributes by determining that distortion correction may be performed on the images based on correction information that is similar to the same correction information. Accordingly, the classification unit 502 may identify a group of two or more imaging units in which the processing of reading correction information from the storage unit 500 may be commonized.

For example, the classification unit 502 may group two or more imaging units for each of which it is determined that distortion correction may be performed on an image based on correction information included in a plurality of pieces of correction information among the plurality of imaging units. The plurality of pieces of correction information includes correction information that is generable based on reference correction information and any piece of difference information stored in the storage unit 500.

For example, the classification unit 502 groups two or more imaging units having the same or similar attributes by determining that distortion correction may be performed on an image based on correction information included in the plurality of pieces of correction information. Accordingly, the classification unit 502 may identify a group of two or more imaging units in which the processing of reading correction information from the storage unit 500 may be commonized.

For example, the classification unit 502 groups two or more imaging units that capture different images having the same or similar attributes by determining that distortion correction may be performed on the images based on correction information included in the plurality of pieces of correction information. Accordingly, the classification unit 502 may identify a group of two or more imaging units in which the processing of reading correction information from the storage unit 500 may be commonized.

The correction unit 503 performs distortion correction on an image captured by each imaging unit of two or more grouped imaging units. For example, the correction unit 503 refers to the storage contents of the storage unit 500, and acquires first correction information that enables distortion correction to be directly performed on an image captured by each imaging unit of the two or more grouped imaging units.

For example, the correction unit 503 identifies as the first correction information and acquires correction information corresponding to any imaging unit of the two or more grouped imaging units in the storage contents of the storage unit 500. For example, the correction unit 503 refers to the storage contents of the storage unit 500 and identifies and acquires the first correction information based on the attribute of at least any imaging unit of the two or more grouped imaging units. For example, the correction unit 503 refers to the storage contents of the storage unit 500 and identifies and acquires the first correction information based on the attribute information of an image captured by at least any imaging unit of the two or more grouped imaging units.

For example, the correction unit 503 performs distortion correction on an image captured by each imaging unit of the two or more grouped imaging units based on the acquired first correction information. Accordingly, the correction unit 503 may achieve reduction in band usage of the storage unit 500 when distortion correction is performed on an image captured by each imaging unit of the two or more imaging units. For example, band usage is the band usage of the DRAM included in the memory 302 serving as the storage unit 500 and the FPGA 306 serving as the correction unit 503.

For example, the correction unit 503 may determine whether the band usage of the storage unit 500 exceeds a threshold. For example, when the band usage of the storage unit 500 exceeds the threshold, the correction unit 503 refers to the storage contents of the storage unit 500, and acquires a part of the first correction information that enables distortion correction to be directly performed on an image captured by each imaging unit of the two or more grouped imaging units. For example, the correction unit 503 generates second correction information obtained by estimating the first correction information based on the acquired part of the first correction information. For example, the correction unit 503 performs distortion correction on an image captured by each imaging unit of the two or more grouped imaging units based on the generated second correction information. Accordingly, the correction unit 503 may achieve reduction in band usage of the storage unit 500 when distortion correction is performed on an image captured by each imaging unit of the two or more imaging units.

For example, the correction unit 503 may refer to the storage contents of the storage unit 500 and acquire first correction information that makes generable third correction information that enables distortion correction to be performed on an image captured by each imaging unit of the two or more grouped imaging units. For example, for each imaging unit of the two or more grouped imaging units, the correction unit 503 generates third correction information that is similar to the acquired first correction information and that enables distortion correction to be performed on an image captured by the imaging unit. For example, for each imaging unit of the two or more grouped imaging units, the correction unit 503 performs distortion correction on an image captured by the imaging unit based on the generated third correction information. Accordingly, the correction unit 503 may enable distortion correction to be accurately performed on an image captured by each imaging unit of the two or more grouped imaging units.

For example, the correction unit 503 may generate reference correction information from specific parameters. For example, the correction unit 503 refers to the storage contents of the storage unit 500 and acquires, for each imaging unit of the two or more grouped imaging units, difference information corresponding to the imaging unit. For example, for each imaging unit of the two or more grouped imaging units, the correction unit 503 generates fourth correction information that enables distortion correction to be performed on an image captured by the imaging unit, based on the generated reference correction information and the acquired difference information. For example, for each imaging unit of the two or more grouped imaging units, the correction unit 503 performs distortion correction on an image captured by the imaging unit based on the generated fourth correction information. Accordingly, the correction unit 503 may enable distortion correction to be accurately performed on an image captured by each imaging unit of the two or more grouped imaging units.

The storing unit 504 generates first correction information based on the characteristics of the two or more grouped imaging units, and stores the first correction information in the storage unit 500. Accordingly, the storing unit 504 may enable distortion correction to be performed on an image captured by each imaging unit of the two or more grouped imaging units.

The output unit 505 outputs a processing result of at least any functional unit. For example, the output form is display on a display, output to a printer for printing, transmission to an external device through the network I/F 303, or storage in a storage area such as the memory 302 or the recording medium 305. Accordingly, the output unit 505 may enable a processing result of at least any functional unit to be notified to a user and achieve improvement in the convenience of the information processing apparatus 100.

For example, the output unit 505 outputs an image after correction corrected by the correction unit 503. For example, the output unit 505 outputs the image after correction so that a user may refer to the image. For example, the output unit 505 may output the image after correction to an analysis unit (not illustrated) that analyzes an image or the like. Accordingly, the output unit 505 may output a useful image. For example, the output unit 505 may enable a user to use a useful image. For example, the output unit 505 may achieve improvement in the accuracy of analysis based on an image.

### (Operation Example 1 of Information Processing Apparatus 100)

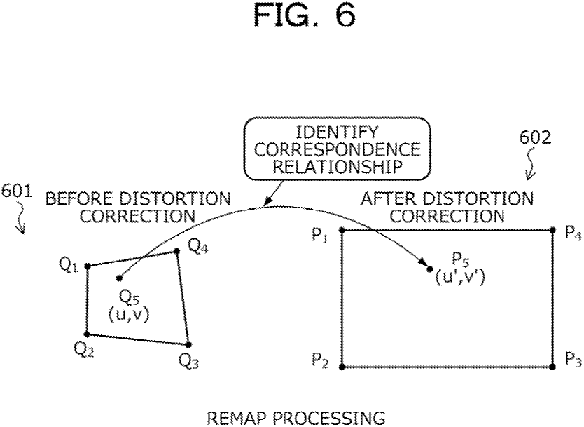

Next, operation example 1 of the information processing apparatus 100 will be described with reference to FIGS. 6 to 12. First, for example, the details of remap processing in which distortion correction is performed will be described with reference to FIG. 6.

FIG. 6 is an explanatory diagram illustrating the details of remap processing. As illustrated in FIG. 6, remap processing is processing of identifying the correspondence relationship between a pixel in an image 601 before distortion correction and a pixel in an image 602 after distortion correction, and generating the image 602 by performing distortion correction on the image 601.

For example, the correspondence relationship between pixel Q₅ of the coordinates (u, v) in the image 601 and pixel P₅ of the coordinates (u′, v′) in the image 602 is identified. For example, correspondence relationship is defined by a remap table. For example, the following references 1 to 3 and the like may be referred to regarding distortion correction.
Reference 1: Zhang, Zhengyou, “A Flexible New Technique for Camera Calibration” IEEE Transactions on Pattern Analysis and Machine Intelligence, Volume 22, Issue 11, pp. 1330-1334, 2000
Reference 2: Kadota, Hitoshi and Fujita, Satoru, “Method of Distortion Correction for 3D Capturing” Collection of Lectures and Papers for the 76th National Convention, 2014. 1, pp. 215-216, 2014
Reference 3: “Camera Calibration and 3D Reconstruction”, [online], 2010, [searched on Feb. 25, 2022], Internet <URL: http://opencv.jp/opencv-2.1/cpp/camera_calibration_and_3d_reconstruction.html>

For example, the correspondence relationship between the coordinates (u, v) and the coordinates (u′, v′) is identified by the following formulae (1) to (6), and is managed as a remap table.

$$\text{x} \text{=} \left(\text{u′} \text{-} {\text{c}}_{\text{x}}\right) / {\text{f}}_{\text{x}} \qquad \text{(1)}$$

$$\text{y} \text{=} \left(\text{u′} \text{-} {\text{c}}_{\text{y}}\right) / {\text{f}}_{\text{y}} \qquad \text{(2)}$$

$$\text{x′} = \text{x} \left(\text{1} + {\text{k}}_{\text{1}} {\text{r}}^{\text{2}} + {\text{k}}_{\text{2}} {\text{r}}^{\text{2}}\right) + {\text{2p}}_{\text{1}} \text{xy} + {\text{p}}_{\text{2}} \left({\text{r}}^{\text{2}} + {\text{2x}}^{\text{2}}\right) \qquad \text{(3)}$$

$$\text{y′} = \text{y} \left(\text{1} + {\text{k}}_{\text{1}} {\text{r}}^{\text{2}} + {\text{k}}_{\text{2}} {\text{r}}^{\text{2}}\right) + {\text{p}}_{1} \left({\text{r}}^{\text{2}} + {\text{2x}}^{\text{2}}\right) + {\text{2p}}_{\text{2}} \text{xy} \qquad \text{(4)}$$

$$\text{u} = \left({\text{f}}_{\text{x}} \text{x′}\right) + {\text{c}}_{\text{x}} \qquad \text{(5)}$$

$$\text{v} = \left({\text{f}}_{\text{y}} \text{y′}\right) + {\text{c}}_{\text{y}} \qquad \text{(6)}$$

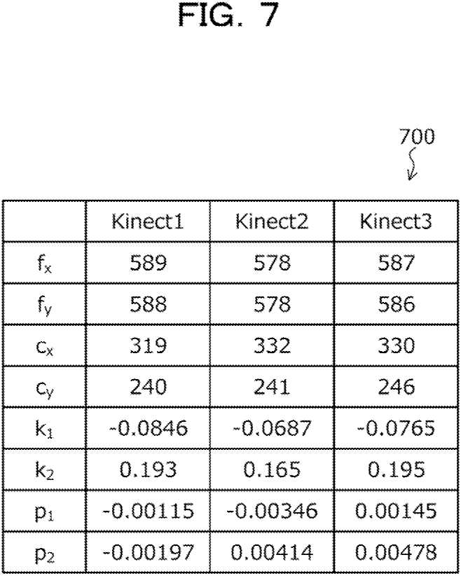

fₓ and f_{y} are focal lengths in units of pixels. cₓ and c_{y} are principal points. For example, a principal point is the center point of an image. k₁ and k₂ are distortion coefficients in the radial direction. p₁ and p₂ are distortion coefficients in the circumferential direction. fₓ, f_{y}, cₓ, _{Cy}, k₁, k₂, p₁, and _{P2} are referred to as correction parameters. Next, a specific example of correction parameters will be described with reference to FIG. 7.

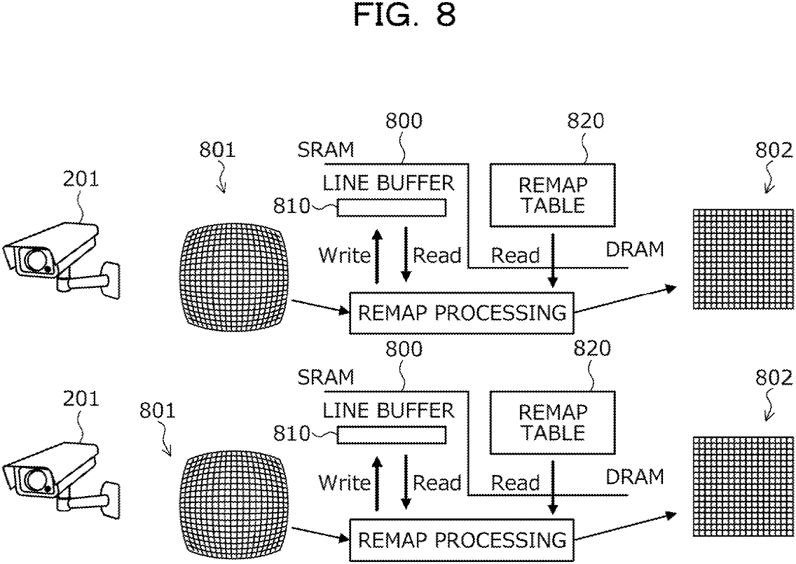

FIG. 7 is an explanatory diagram illustrating a specific example of correction parameters. Table 700 in FIG. 7 illustrates a specific example of correction parameters of each image capturing device 201 of three image capturing devices 201 of Kinect (registered trademark). For convenience, the respective image capturing devices 201 may be referred to as Kinect1, Kinect2, and Kinect3. Next, an example of a situation in which distortion correction is performed will be described with reference to FIG. 8.

FIG. 8 is an explanatory diagram illustrating an example of a situation in which distortion correction is performed. In FIG. 8, for example, a situation is assumed in which it is desired to perform distortion correction on an image 801 captured by each image capturing device 201 of two image capturing devices 201 and generate an image 802 after distortion correction.

In related art, in such a situation, as illustrated in FIG. 8, for each image capturing device 201, a line buffer 810 that stores each part of the image 801 captured by the image capturing device 201 and a remap table 820 are prepared. For example, the line buffer 810 is prepared in an FPGA 800 of related art. The remap table 820 corresponds to each image capturing device 201, and enables distortion correction to be performed on the image 801 captured by the image capturing device 201. For example, the remap table 820 is prepared outside the FPGA 800 of related art. For example, the remap table 820 is stored in a main storage device.

For each image capturing device 201, the FPGA 800 of related art reads the remap table 820 corresponding to the image capturing device 201, and performs distortion correction on each part, that has been read to the line buffer 810, of the image 801 captured by the image capturing device 201. In related art, since the corresponding remap table 820 is read for each image capturing device 201, an increase in band usage for a main storage device that stores the remap table 820 is caused.

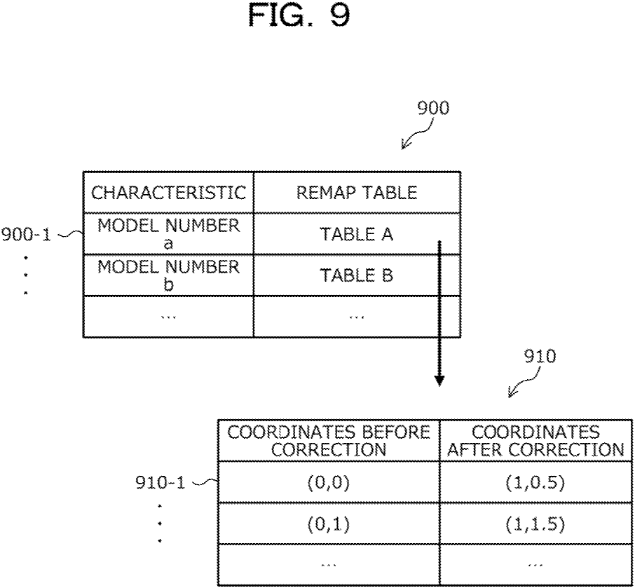

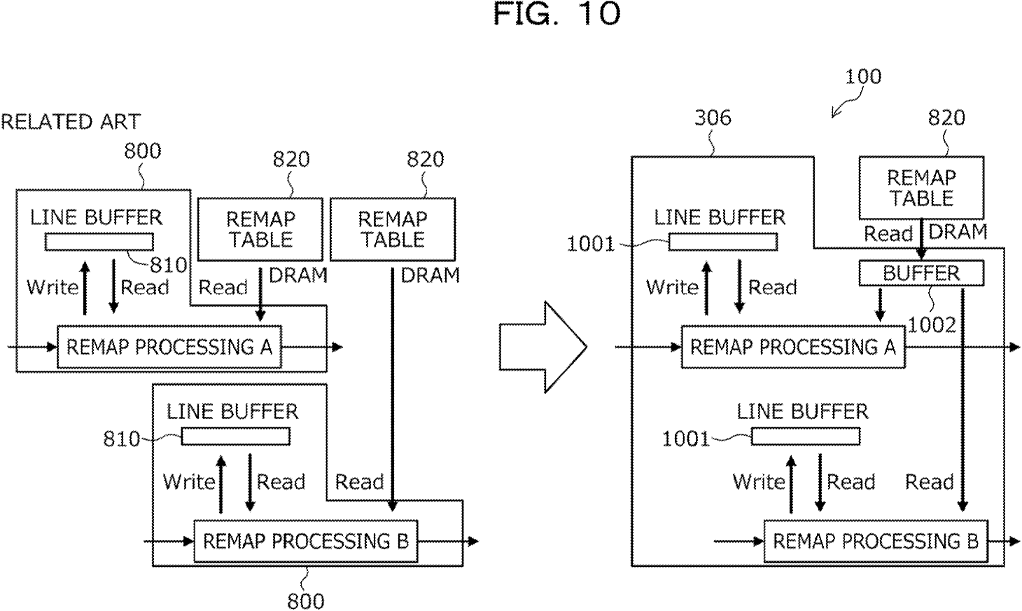

It is conceivable that the information processing apparatus 100 is applied in such a situation. Next, description will be given with reference to FIGS. 9 and 10 for operation example 1 in a case in which the information processing apparatus 100 is applied in the above situation. First, for example, description will be given with reference to FIG. 9 for an example of a management table 900 and a remap table 910 prepared in the DRAM of the memory 302 in operation example 1.

FIG. 9 is an explanatory diagram illustrating an example of the management table 900 and the remap table 910. For example, the management table 900 is realized by a storage area such as the memory 302 or the recording medium 305 of the information processing apparatus 100 illustrated in FIG. 3. For example, the remap table 910 is realized by a storage area such as the memory 302 or the recording medium 305 of the information processing apparatus 100 illustrated in FIG. 3.

As illustrated in FIG. 9, the management table 900 includes the fields of characteristic and remap table. In the management table 900, management information is stored as a record 900-a by setting information in each field for each characteristic. a is a given integer.

The characteristic of the image capturing device 201 is set in the field of characteristic. For example, the characteristic is the attribute of the image capturing device 201. For example, the attribute is a model number or the like. For example, the characteristic may be the attribute of a lens of a camera included in the image capturing device 201. For example, the characteristic may be the attribute of an image captured by the image capturing device 201. Identification information of the remap table corresponding to the above image capturing device 201 is set in the field of remap table.

As illustrated in FIG. 9, the remap table 910 includes the fields of coordinates before correction and coordinates after correction. In the remap table 910, remap information is stored as a record 910-b by setting information in each field for each coordinate pair. b is a given integer.

Coordinates before correction indicating the coordinates of a pixel included in an image before distortion correction are set in the field of coordinates before correction. Coordinates after correction representing the coordinates of a pixel included in an image after distortion correction corresponding to the above coordinates before correction are set in the field of coordinates after correction. The coordinate pair of the above coordinates before correction and the above coordinates after correction may enable distortion correction to be performed on an image. Next, operation example 1 of the information processing apparatus 100 will be described with reference to FIG. 10.

FIG. 10 is an explanatory diagram illustrating operation example 1 of the information processing apparatus 100. In FIG. 10, before the start of actual operation of the information processing system 200, the information processing apparatus 100 receives, from each image capturing device 201 of a plurality of image capturing devices 201, an image captured by the image capturing device 201 and accompanying data related to the image. For example, the plurality of image capturing devices 201 is included in the information processing system 200 or is scheduled to be included in the information processing system 200. For example, the accompanying data includes the attribute of the image capturing device 201 and correction parameters related to distortion correction. For example, the attribute is a model number or the like.

Based on the received accompanying data, the information processing apparatus 100 groups two or more image capturing devices 201 for each of which it is determined that distortion correction may be directly performed on an image based on the same remap table 820 among the plurality of image capturing devices 201. For example, the information processing apparatus 100 groups two or more image capturing devices 201 having the same model number. Accordingly, the information processing apparatus 100 may group two or more image capturing devices 201 in which the processing of reading the remap table 820 may be commonized when performing distortion correction on an image.

In the example of FIG. 10, the information processing apparatus 100 groups two image capturing devices 201 having the same model number. The information processing apparatus 100 generates the remap table 820 based on the correction parameters included in the accompanying data that has been received from each image capturing device 201 of the two grouped image capturing devices 201. For example, the information processing apparatus 100 may generate the remap table 820 based on the average values of the correction parameters included in the accompanying data that has been received from each image capturing device 201. For example, the remap table 820 corresponds to the remap table 910 illustrated in FIG. 9. The information processing apparatus 100 may generate the management table 900 illustrated in FIG. 9 (not illustrated) by associating the generated remap table 820 with the same model number of the two grouped image capturing devices 201.

The information processing apparatus 100 stores the generated remap table 820 in the DRAM of the memory 302 such that the FPGA 306 may access the DRAM. After the start of actual operation of the information processing system 200, the information processing apparatus 100 causes the FPGA 306 to refer to the remap table 820 and perform distortion correction on an image captured by each image capturing device 201 of the two grouped image capturing devices 201.

For each image capturing device 201 of the two grouped image capturing devices 201, the FPGA 306 includes a line buffer 1001 that stores each part of an image captured by the image capturing device 201. The FPGA 306 includes a buffer 1002 that is common to the two grouped image capturing devices 201 and stores the remap table 820.

The FPGA 306 reads the remap table 820 associated with the same model number of the two grouped image capturing devices 201 into the buffer 1002. When receiving an image captured by each image capturing device 201 of the two grouped image capturing devices 201, the FPGA 306 reads the remap table 820 temporarily stored in the buffer 1002 and performs remap processing on the received image.

For example, the FPGA 306 performs remap processing A on an image captured by one image capturing device 201 of the two grouped image capturing devices 201. For example, the FPGA 306 performs remap processing B on an image captured by the other image capturing device 201 of the two grouped image capturing devices 201.

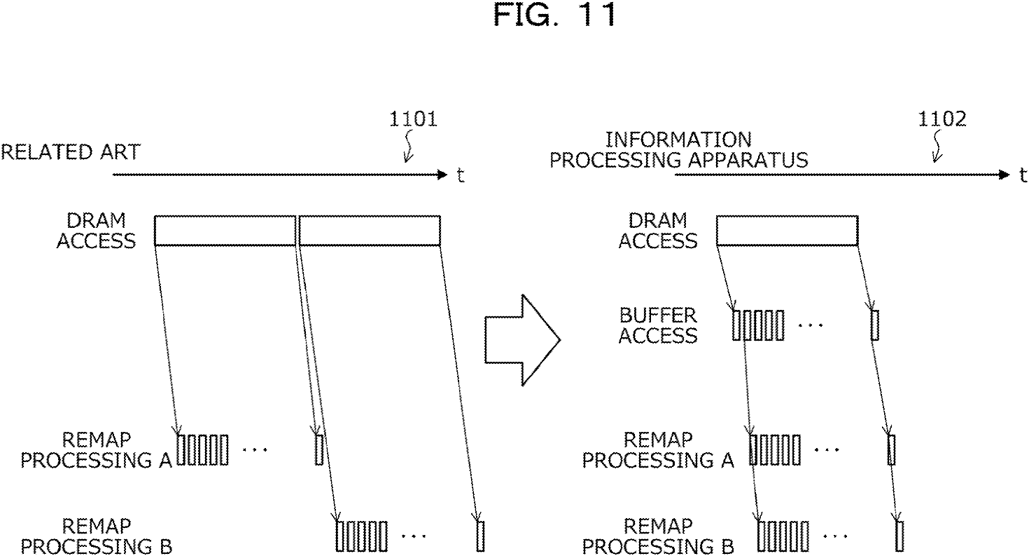

Accordingly, the information processing apparatus 100 may commonize the processing of reading the remap table 820 when performing distortion correction on an image captured by each image capturing device 201 of the two image capturing devices 201. For this reason, the information processing apparatus 100 may suppress an increase in band usage for the DRAM of the memory 302. The information processing apparatus 100 may achieve reduction in the processing time taken to perform distortion correction on an image captured by each image capturing device 201 of the two image capturing devices 201. Next, an example of an effect produced by the information processing apparatus 100 will be described with reference to FIG. 11.

FIG. 11 is an explanatory diagram illustrating an example of an effect produced by the information processing apparatus 100. In FIG. 11, the FPGA 800 of related art reads the external remap table 820 one at a time in terms of band usage. For this reason, as illustrated in the graph 1101 in FIG. 11, the FPGA 800 of related art performs the remap processing A while reading a certain remap table 820, and then performs the remap processing B while reading another remap table 820. Accordingly, there is a problem that the processing time taken to perform distortion correction on a plurality of images is likely to increase.

Similarly, the FPGA 306 of the information processing apparatus 100 reads the remap table 820 one at a time in terms of band usage. The FPGA 306 may perform the remap processing A and the remap processing B in parallel while reading the remap table 820 and temporarily storing the remap table in the buffer 1002. The FPGA 306 synchronizes the remap processing A and the remap processing B when the remap processing A and the remap processing B are performed in parallel while reading each part of the remap table 820 and temporarily storing the read part in the buffer 1002.

Accordingly, the FPGA 306 may achieve reduction in the processing time taken to perform distortion correction on a plurality of images, as compared with the FPGA 800 of related art. The FPGA 306 may suppress an increase in band usage for the processing of reading the remap table 820 when distortion correction is performed on a plurality of images.

For example, a case is assumed in which there are the image capturing devices 201 for 5 ch, and each image capturing device 201 captures an image of 1280 × 720 in 30 fps. The remap table 820 is 5.53 MB. In this case, the FPGA 800 of related art uses a band of 5.53 MB × 30 fps × 5 ch = 829.4 MB/s.

On the other hand, for example, the information processing apparatus 100 groups the image capturing devices 201 for 5 ch into two groups. For this reason, the FPGA 306 uses a band of 5.53 MB × 30 fps × 2 groups = 331.8 MB/s. As described above, the information processing apparatus 100 may achieve reduction in band usage for the processing of reading the remap table 820, as compared with related art.

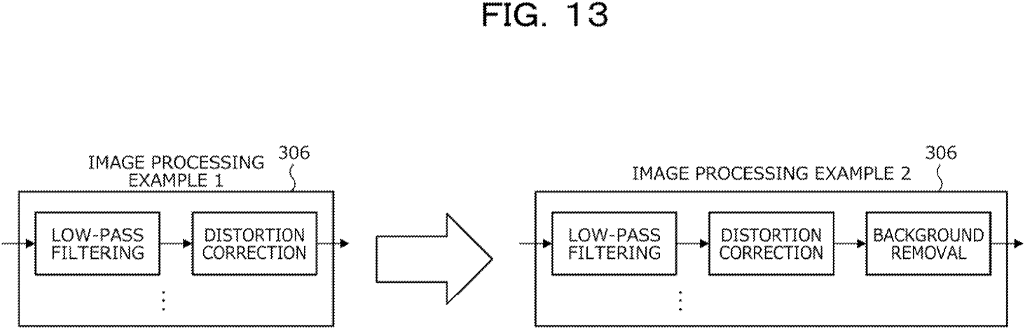

Although a case has been described in which the FPGA 306 reads the entire remap table 820 as it is, this is not the only case. For example, there may be a case in which the FPGA 306 reads a part of the remap table 820 and estimates and uses the entire remap table 820. In this case, the FPGA 306 may achieve further reduction in band usage for the processing of reading the remap table 820. For a specific example of this case, for example, operation example 2 to be described later with reference to FIGS. 13 to 15 may be referred to.

Although a case has been described in which the information processing apparatus 100 groups two or more image capturing devices 201 for each of which it is determined that distortion correction may be performed on an image based on the same remap table 820, this is not the only case. For example, there may be a case in which the information processing apparatus 100 groups two or more image capturing devices 201 for each of which it is determined that distortion correction may be performed on an image based on different remap tables 820.

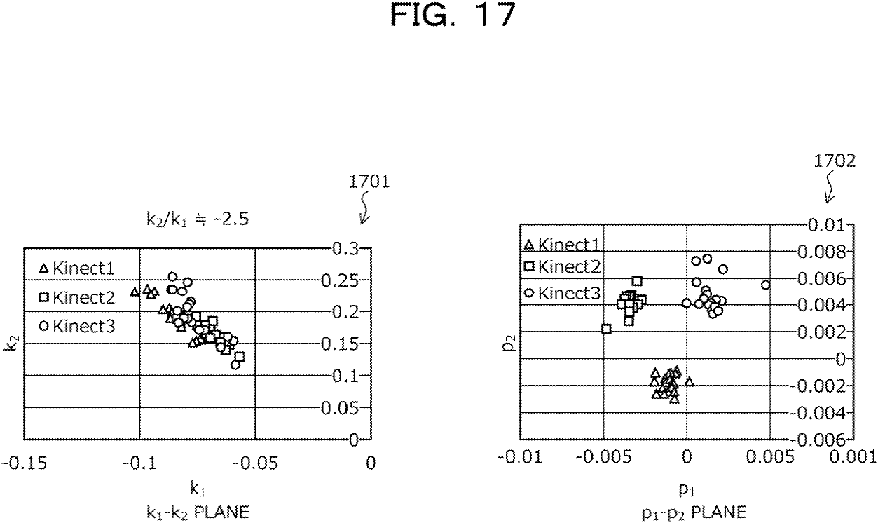

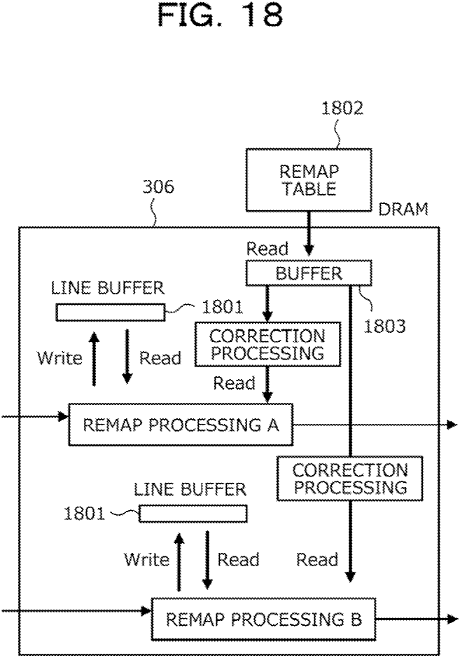

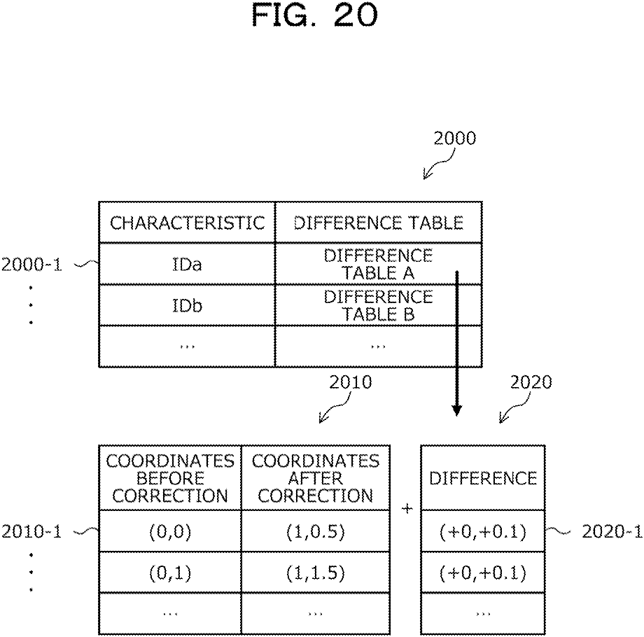

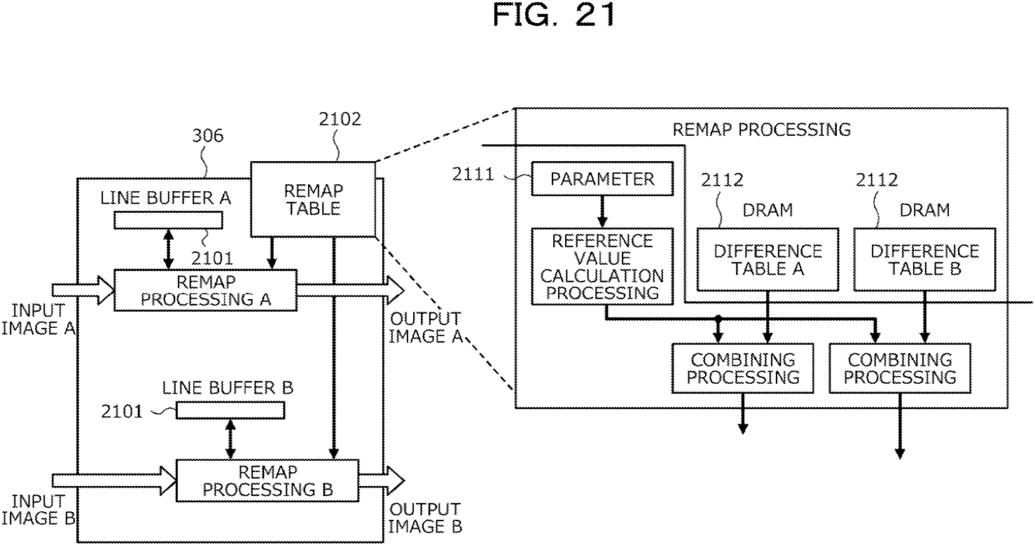

For example, there may be a case in which the information processing apparatus 100 includes, in the same group, the image capturing devices 201 for which it is determined that distortion correction may be performed on an image based on each of two or more remap tables 820 generable from a certain remap table 820. For a specific example of this case, for example, operation example 3 to be described later with reference to FIGS. 17 and 18, operation example 4 to be described later with reference to FIGS. 20 and 21, or the like may be referred to.

### Overall Processing Procedure in Operation Example 1

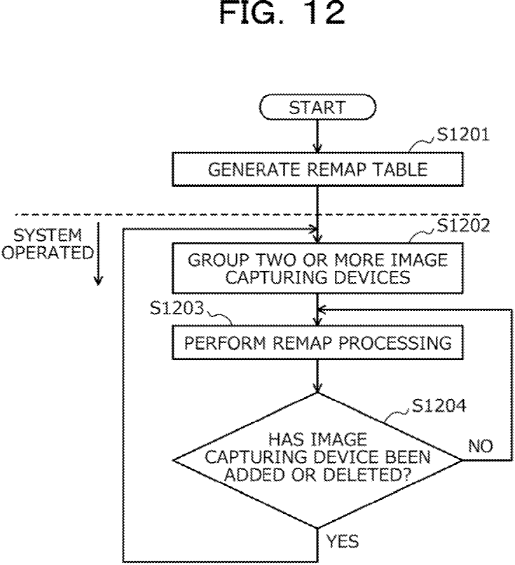

Next, an example of an overall processing procedure executed by the information processing apparatus 100 in operation example 1 will be described with reference to FIG. 12. For example, the overall processing is achieved by the CPU 301, a storage area such as the memory 302 or the recording medium 305, the network I/F 303, and the FPGA 306, which are illustrated in FIG. 3.

FIG. 12 is a flowchart illustrating an example of an overall processing procedure in operation example 1. In FIG. 12, the information processing apparatus 100 performs calibration of the image capturing device 201 to be installed in advance, and generates the remap table 820 associated with the model number of the image capturing device 201 (step S1201). For example, the information processing apparatus 100 generates the remap table 820 associated with the model number of the image capturing device 201 before the information processing system 200 is operated.

Next, the information processing apparatus 100 groups two or more image capturing devices 201 of the same model number based on the model number of each image capturing device 201 of a plurality of installed image capturing devices 201 (step S1202). For example, the information processing apparatus 100 groups two or more image capturing devices 201 of the same model number after the information processing system 200 is operated.

The information processing apparatus 100 performs remap processing on the images captured by the two or more grouped image capturing devices 201, based on the remap table 820 corresponding to the same model number of the two or more image capturing devices 201 (step S1203).

Next, the information processing apparatus 100 determines whether the image capturing device 201 has been added to or deleted from the information processing system 200 (step S1204). When the image capturing device 201 has been added or deleted (step S1204: Yes), the information processing apparatus 100 returns to the processing of step S1202. On the other hand, when the image capturing device 201 has not been added and the image capturing device 201 has not been deleted (step S1204: No), the information processing apparatus 100 returns to the processing of step S1203.

### (Operation Example 2 of Information Processing Apparatus 100)

Next, operation example 2 of the information processing apparatus 100 will be described with reference to FIGS. 13 to 15. First, an example of image processing including distortion correction will be described with reference to FIG. 13.

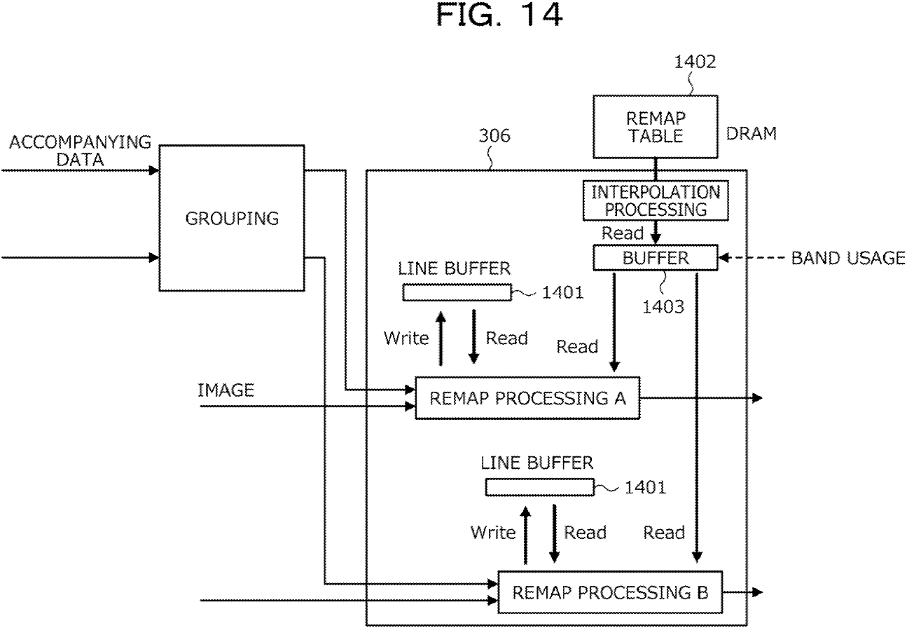

FIG. 13 is an explanatory diagram illustrating an example of image processing. As illustrated in FIG. 13, for example, the FPGA 306 performs lowpass filtering and distortion correction. For example, the details of processing by the FPGA 306 may be dynamically changed and background removal may be further performed. Accordingly, it is conceivable that the band usage by the FPGA 306 for the DRAM of the memory 302 dynamically changes. For this reason, it is desired that the information processing apparatus 100 deals with a dynamically changing band usage. Operation example 2 is an operation example in which the information processing apparatus 100 may deal with a dynamically changing band usage. Next, operation example 2 of the information processing apparatus 100 will be described with reference to FIG. 14.

FIG. 14 is an explanatory diagram illustrating operation example 2 of the information processing apparatus 100. In FIG. 14, before the start of actual operation of the information processing system 200, the information processing apparatus 100 receives, from each image capturing device 201 of a plurality of image capturing devices 201, an image captured by the image capturing device 201 and accompanying data related to the image. For example, the plurality of image capturing devices 201 is included in the information processing system 200 or is scheduled to be included in the information processing system 200. For example, the accompanying data includes the attribute of the image capturing device 201 and correction parameters related to distortion correction. For example, the attribute is a model number or the like.

Based on the received accompanying data, the information processing apparatus 100 groups two or more image capturing devices 201 for each of which it is determined that distortion correction may be directly performed on an image based on the same remap table 1402 among the plurality of image capturing devices 201. For example, the information processing apparatus 100 groups two or more image capturing devices 201 having the same model number. Accordingly, the information processing apparatus 100 may group two or more image capturing devices 201 in which the processing of reading the remap table 1402 may be commonized when performing distortion correction on an image.

In the example of FIG. 14, the information processing apparatus 100 groups two image capturing devices 201 having the same model number. The information processing apparatus 100 generates the remap table 1402 based on the correction parameters included in the accompanying data that has been received from each image capturing device 201 of the two grouped image capturing devices 201. For example, the information processing apparatus 100 may generate the remap table 1402 based on the average values of the correction parameters included in the accompanying data that has been received from each image capturing device 201. The information processing apparatus 100 may generate the management table 900 illustrated in FIG. 9 (not illustrated) by associating the generated remap table 1402 with the same model number of the two grouped image capturing devices 201.

The information processing apparatus 100 stores the generated remap table 1402 in the DRAM of the memory 302 such that the FPGA 306 may access the DRAM. After the start of actual operation of the information processing system 200, the information processing apparatus 100 causes the FPGA 306 to refer to the remap table 1402 and perform distortion correction on an image captured by each image capturing device 201 of the two grouped image capturing devices 201.

For each image capturing device 201 of the two grouped image capturing devices 201, the FPGA 306 includes a line buffer 1401 that stores each part of an image captured by the image capturing device 201. The FPGA 306 includes a buffer 1403 that is common to the two grouped image capturing devices 201 and stores the remap table 1402.

The FPGA 306 determines whether the band usage for the DRAM of the memory 302 has exceeded a threshold. When the band usage is equal to or less than the threshold, the FPGA 306 reads and uses the remap table 1402 as it is. On the other hand, when the band usage has exceeded the threshold, the FPGA 306 reads a part of the remap table 1402, performs interpolation processing on the part of the remap table 1402, and estimates and uses the original remap table 1402.

For example, when the band usage is equal to or less than the threshold, as in operation example 1, the FPGA 306 reads the remap table 1402 associated with the same model number of the two grouped image capturing devices 201 into the buffer 1403. As in operation example 1, when receiving an image captured by each image capturing device 201, the FPGA 306 reads the remap table 1402 temporarily stored in the buffer 1403 and performs remap processing on the image.

On the other hand, for example, when the band usage has exceeded the threshold, the FPGA 306 reads a part of the remap table 1402 associated with the same model number of the two grouped image capturing devices 201. For example, a part is 1/n of the remap table 1402. n is an integer equal to or greater than 2. For example, a part is obtained by extracting information on coordinates for each predetermined width from the successive pieces of information on coordinates indicated by the remap table 1402.

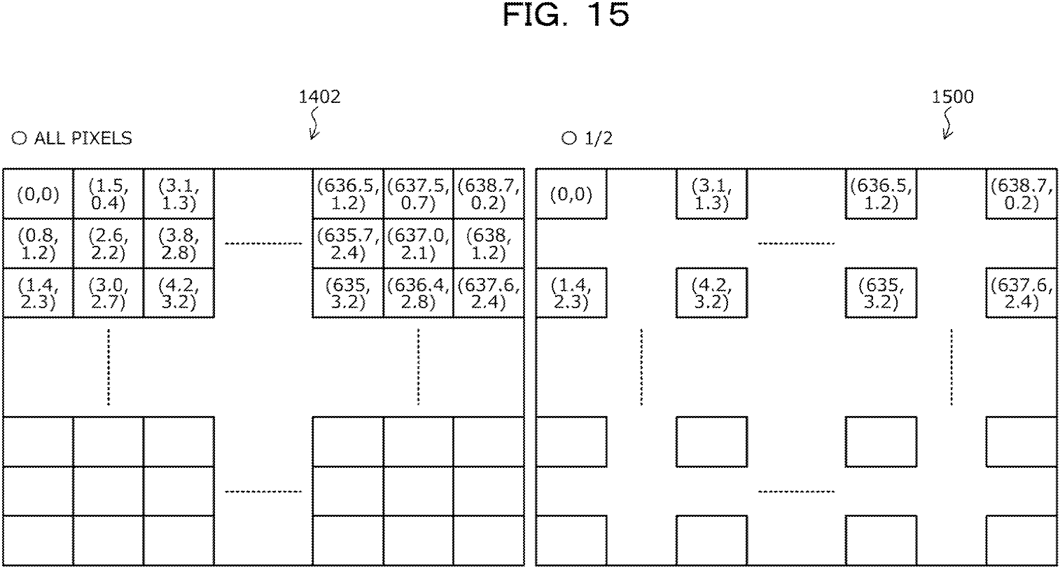

For example, the FPGA 306 estimates the remap table 1402 by performing interpolation processing on the read part. An example in which the FPGA 306 estimates the remap table 1402 will be described later with reference to FIG. 15.

For example, the FPGA 306 stores the estimated remap table 1402 in the buffer 1403. For example, when receiving an image captured by each image capturing device 201, the FPGA 306 reads the remap table 1402 temporarily stored in the buffer 1403 and performs remap processing on the image.

For example, the FPGA 306 performs the remap processing A on an image captured by one image capturing device 201 of the two grouped image capturing devices 201. For example, the FPGA 306 performs the remap processing B on an image captured by the other image capturing device 201 of the two grouped image capturing devices 201.

Accordingly, the information processing apparatus 100 may commonize the processing of reading the remap table 1402 when performing distortion correction on an image captured by each image capturing device 201 of the two image capturing devices 201. For this reason, the information processing apparatus 100 may suppress an increase in band usage for the DRAM of the memory 302. The information processing apparatus 100 may achieve reduction in the processing time taken to perform distortion correction on an image captured by each image capturing device 201 of the two image capturing devices 201.

The information processing apparatus 100 may deal with a dynamically changing band usage. For example, the information processing apparatus 100 may achieve reduction in band usage in response to the fact that the band usage has exceeded the threshold. For this reason, the information processing apparatus 100 may suppress an increase in band usage for the DRAM of the memory 302. The information processing apparatus 100 may achieve reduction in the processing time taken to perform distortion correction on an image captured by each image capturing device 201 of the two image capturing devices 201.

For example, a case is assumed in which there are the image capturing devices 201 for 5 ch, and each image capturing device 201 captures an image of 1280 × 720 in 30 fps. In operation example 2, the information processing apparatus 100 may suppress the band usage to 165.9 MB/s by the interpolation processing. Next, an example in which the FPGA 306 estimates the remap table 1402 will be described with reference to FIG. 15.

FIG. 15 is an explanatory diagram illustrating an example of estimating the remap table 1402. As illustrated in FIG. 15, the remap table 1402 indicates the correspondence relationship between coordinates before correction representing the coordinates of a pixel in an image before distortion correction and coordinates after correction representing the coordinates of a pixel in an image after distortion correction corresponding to the pixel in the image before distortion correction. In the example of FIG. 15, (i, j) indicates coordinates after correction. i and j are natural numbers. The position of a rectangle in which (i, j) is described indicates coordinates before correction.

For example, when the band usage has exceeded the threshold, the FPGA 306 reads a thinned table 1500 instead of the entire remap table 1402. The thinned table 1500 indicates the correspondence relationship between coordinates before correction and coordinates after correction for each of the odd-numbered pixels in an image before distortion correction in the column direction. For example, the FPGA 306 performs interpolation processing on the thinned table 1500 and estimates the remap table 1402.

For example, the FPGA 306 estimates the remap table 1402 based on the thinned table 1500 by linear interpolation. For example, the FPGA 306 estimates the correspondence relationship between coordinates before correction and coordinates after correction for each of the even-numbered pixels in an image before distortion correction in the column direction, based on the correspondence relationship between coordinates before correction and coordinates after correction of each of the odd-numbered pixels. Accordingly, the FPGA 306 may accurately estimate the remap table 1402.

### Overall Processing Procedure in Operation Example 2

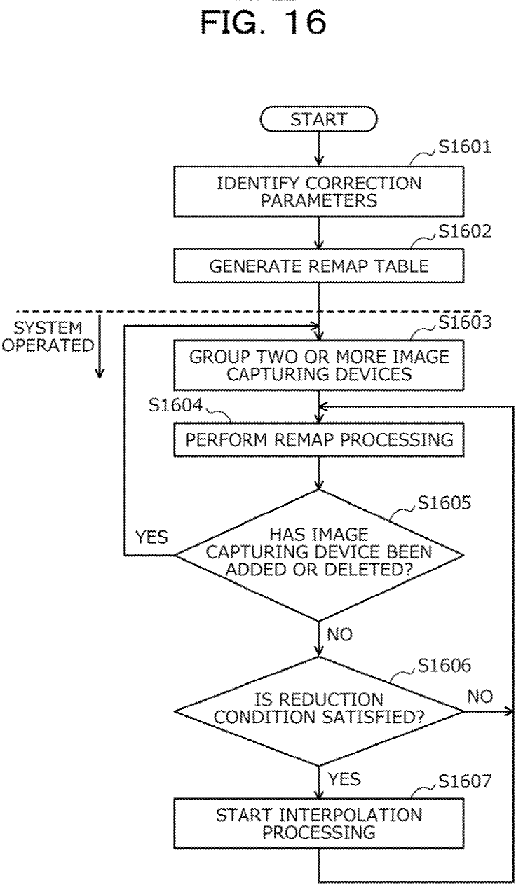

Next, an example of an overall processing procedure executed by the information processing apparatus 100 in operation example 2 will be described with reference to FIG. 16. For example, the overall processing is achieved by the CPU 301, a storage area such as the memory 302 or the recording medium 305, the network I/F 303, and the FPGA 306, which are illustrated in FIG. 3.

FIG. 16 is a flowchart illustrating an example of an overall processing procedure in operation example 2. In FIG. 16, the information processing apparatus 100 performs calibration of the image capturing device 201 to be installed in advance, and identifies correction parameters (step S1601).

Next, based on the identified correction parameters, the information processing apparatus 100 generates the remap table 1402 associated with the model number of the image capturing device 201 to be installed (step S1602). For example, the information processing apparatus 100 generates the remap table 1402 associated with the model number of the image capturing device 201 before the information processing system 200 is operated.

Next, the information processing apparatus 100 groups two or more image capturing devices 201 of the same model number based on the model number of each image capturing device 201 of a plurality of installed image capturing devices 201 (step S1603). For example, the information processing apparatus 100 groups two or more image capturing devices 201 of the same model number after the information processing system 200 is operated.

The information processing apparatus 100 performs remap processing on the images captured by the two or more grouped image capturing devices 201, based on the remap table 1402 corresponding to the same model number of the two or more image capturing devices 201 (step S1604). The remap processing includes interpolation processing that has not been started. In the remap processing, if interpolation processing has not been started, the entire remap table 1402 is read and distortion correction is performed.

Next, the information processing apparatus 100 determines whether the image capturing device 201 has been added or deleted (step S1605). When the image capturing device 201 has been added or deleted (step S1605: Yes), the information processing apparatus 100 returns to the processing of step S1603. On the other hand, when the image capturing device 201 has not been added and the image capturing device 201 has not been deleted (step S1605: No), the information processing apparatus 100 proceeds to the processing of step S1606.

In step S1606, the information processing apparatus 100 determines whether a reduction condition of band usage is satisfied (step S1606). The reduction condition is that the band usage exceeds a threshold. When the reduction condition is not satisfied (step S1606: No), the information processing apparatus 100 returns to the processing of step S1604. On the other hand, when the reduction condition is satisfied (step S1606: Yes), the information processing apparatus 100 proceeds to the processing of step S1607.

In step S1607, the information processing apparatus 100 starts the interpolation processing included in the remap processing (step S1607). In the remap processing, if the interpolation processing has been started, a part of the remap table 1402 is read, the entire remap table 1402 is estimated, and distortion correction is performed. The information processing apparatus 100 returns to the processing of step S1604.

### (Operation Example 3 of Information Processing Apparatus 100)

Next, operation example 3 of the information processing apparatus 100 will be described with reference to FIGS. 17 and 18.

There may be a case in which the distortion states of images captured by a plurality of image capturing devices 201 of the same model number are not the same. For example, there may be a situation in which the distortion state of an image changes due to uneven manufacturing of the image capturing device 201 or the like. For this reason, unique correction parameters are used instead of those common to the plurality of image capturing devices 201 of the same model number.

Operation example 3 is an operation example corresponding to a case in which, in consideration of the above-described situation and the like, the FPGA 306 performs distortion correction on an image captured by each image capturing device 201 of two or more grouped image capturing devices 201. First, relationship between correction parameters corresponding to different image capturing devices 201 will be described with reference to FIG. 17.

FIG. 17 is an explanatory diagram illustrating the relationship between correction parameters. Graph 1701 in FIG. 17 illustrates the relationship between k₁ and k₂ among the correction parameters for Kinect1, Kinect2, and Kinect3. As illustrated in graph 1701, it is conceivable that k₁ and k₂ have the property that the individual difference between the image capturing devices 201 is relatively small.

Graph 1702 in FIG. 17 illustrates the relationship between p₁ and p₂ among the correction parameters for Kinect1, Kinect2, and Kinect3. As illustrated in graph 1702, it is conceivable that p₁ and p₂ have the property that the individual difference between the image capturing devices 201 is relatively large. Next, operation example 3 of the information processing apparatus 100 will be described with reference to FIG. 18.

FIG. 18 is an explanatory diagram illustrating operation example 3 of the information processing apparatus 100. In consideration of the above-described properties, after a remap table 1802 based on k₁ and k₂ is stored in the DRAM of the memory 302, the FPGA 306 reads the remap table 1802 and performs correction based on p₁ and p₂.

For example, before the start of actual operation of the information processing system 200, the information processing apparatus 100 receives, from each image capturing device 201 of a plurality of image capturing devices 201, an image captured by the image capturing device 201 and accompanying data related to the image. For example, the plurality of image capturing devices 201 is included in the information processing system 200 or is scheduled to be included in the information processing system 200. For example, the accompanying data includes the attribute of the image capturing device 201 and correction parameters related to distortion correction.

Based on the received accompanying data, the information processing apparatus 100 groups two or more image capturing devices 201 for each of which it is determined that distortion correction may be indirectly performed on an image based on the same remap table 1802 among the plurality of image capturing devices 201. For example, the information processing apparatus 100 groups two or more image capturing devices 201 for each of which it is determined that distortion correction may be directly performed based on any remap table 1802′ (not illustrated) that is generable by correcting the same remap table 1802.

For example, the information processing apparatus 100 groups two or more image capturing devices 201 having the same model number. Accordingly, the information processing apparatus 100 may group two or more image capturing devices 201 in which the processing of reading the remap table 1802 may be commonized when performing distortion correction on an image.

In the example of FIG. 18, the information processing apparatus 100 groups two image capturing devices 201 having the same model number. The information processing apparatus 100 generates the remap table 1802 based on the correction parameters included in the accompanying data that has been received from each image capturing device 201 of the two grouped image capturing devices 201.

For example, the information processing apparatus 100 replaces the above formulae (3) and (4) with the following formulae (7) and (8), identifies the correspondence relationship between the coordinates (u, v) and the coordinates (u′, v′), and generates the remap table 1802.

The following formula (7) is a part of the above formula (3). The following formula (7) is a part of the above formula (3) related to k₁ and k₂. The following formula (8) is a part of the above formula (4). The following formula (8) is a part of the above formula (4) related to k₁ and k₂. k₁ and k₂ may be average values.

$$\text{x′} = \text{x} \left(\text{1} + {\text{k}}_{\text{1}} {\text{r}}^{\text{2}} + {\text{k}}_{\text{2}} {\text{r}}^{4}\right) \qquad \text{(7)}$$

$$\text{y′} = \text{y} \left(\text{1} + {\text{k}}_{\text{1}} {\text{r}}^{\text{2}} + {\text{k}}_{\text{2}} {\text{r}}^{4}\right) \qquad \text{(8)}$$

The information processing apparatus 100 may generate the management table 900 illustrated in FIG. 9 (not illustrated) by associating the generated remap table 1802 with the same model number of the two grouped image capturing devices 201.

The information processing apparatus 100 stores the generated remap table 1802 in the DRAM of the memory 302 such that the FPGA 306 may access the DRAM. After the start of actual operation of the information processing system 200, the information processing apparatus 100 causes the FPGA 306 to refer to the remap table 1802 and perform distortion correction on an image captured by each image capturing device 201 of the two grouped image capturing devices 201.

For each image capturing device 201 of the two grouped image capturing devices 201, the FPGA 306 includes a line buffer 1801 that stores each part of an image captured by the image capturing device 201. The FPGA 306 includes a buffer 1803 that is common to the two grouped image capturing devices 201 and stores the remap table 1802.

The FPGA 306 reads the remap table 1802 associated with the same model number of the two grouped image capturing devices 201 into the buffer 1803. When receiving an image captured by each image capturing device 201 of the two grouped image capturing devices 201 and the correction parameters, the FPGA 306 reads the remap table 1802 temporarily stored in the buffer 1803.

The FPGA 306 corrects the read remap table 1802 based on the correction parameters received for an image captured by each image capturing device 201, and generates a remap table 1802′ that enables distortion correction to be performed on the image.

For example, the FPGA 306 identifies the coordinates (u″, v″) corresponding to the coordinates (u′, v′) indicated by the remap table 1802 in accordance with the above formula (1), the above formula (2), and the following formulae (9) to (11), and generates the remap table 1802′. The following formulae (9) to (11) relate to p₁ and p₂ having the property that individual difference is relatively large.

$${\text{r}}^{\text{2}} = {\text{x}}^{\text{2}} + {\text{y}}^{\text{2}} \qquad \text{(9)}$$

$$\text{u″} = \text{u′} + {\text{f}}_{\text{x}} \left({\text{2p}}_{\text{1}} \text{xy} + {\text{p}}_{\text{2}} \left({\text{r}}^{\text{2}} + {\text{2x}}^{\text{2}}\right)\right) \qquad \text{(10)}$$

$$\text{v″} = \text{v′} + {\text{f}}_{\text{y}} \left({\text{p}}_{\text{1}} \left({\text{r}}^{\text{2}} + {\text{2x}}^{\text{2}}\right) + {\text{2p}}_{\text{2}} \text{xy}\right) \qquad \text{(11)}$$

The FPGA 306 performs remap processing on the received image based on the generated remap table 1802′. For example, the FPGA 306 performs the remap processing A on an image captured by one image capturing device 201 of the two grouped image capturing devices 201. For example, the FPGA 306 performs the remap processing B on an image captured by the other image capturing device 201 of the two grouped image capturing devices 201.

Accordingly, the information processing apparatus 100 may commonize the processing of reading the remap table 1802 when performing distortion correction on an image captured by each image capturing device 201 of the two image capturing devices 201. For this reason, the information processing apparatus 100 may suppress an increase in band usage for the DRAM of the memory 302.

For example, a case is assumed in which there are the image capturing devices 201 for 5 ch, and each image capturing device 201 captures an image of 1280 × 720 in 30 fps. In operation example 3, the information processing apparatus 100 may group a plurality of image capturing devices 201 respectively corresponding to different remap tables 1802′. For this reason, for example, the information processing apparatus 100 groups the image capturing devices 201 for 5 ch into one group. For this reason, the information processing apparatus 100 may suppress the band usage to 165.9 MB/s.

The information processing apparatus 100 may achieve reduction in the processing time taken to perform distortion correction on an image captured by each image capturing device 201 of the two image capturing devices 201. Since the remap table 1802′ suitable for each image capturing device 201 is generable based on the remap table 1802, the information processing apparatus 100 may enable distortion correction to be accurately performed on an image captured by each image capturing device 201. Since the information processing apparatus 100 may group the plurality of image capturing devices 201 respectively corresponding to different remap tables 1802′, an increase in band usage for the DRAM of the memory 302 may be easily suppressed.

Although a case has been described in which the information processing apparatus 100 groups two or more image capturing devices 201 having the same model number, this is not the only case. For example, there may be a case in which the information processing apparatus 100 groups two or more image capturing devices 201 having different model numbers. Since the remap table 1802′ suitable for each image capturing device 201 is generable, the information processing apparatus 100 may also be applied in this case.

### Overall Processing Procedure in Operation Example 3

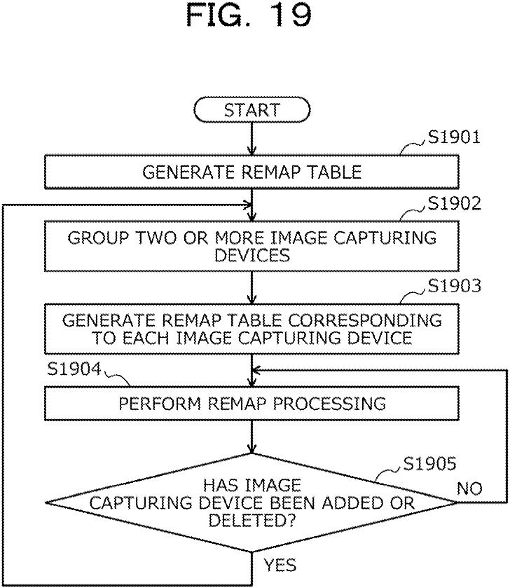

Next, an example of an overall processing procedure executed by the information processing apparatus 100 in operation example 3 will be described with reference to FIG. 19. For example, the overall processing is achieved by the CPU 301, a storage area such as the memory 302 or the recording medium 305, the network I/F 303, and the FPGA 306, which are illustrated in FIG. 3.

FIG. 19 is a flowchart illustrating an example of an overall processing procedure in operation example 3. In FIG. 19, the information processing apparatus 100 performs calibration of the image capturing device 201 to be installed in advance, and generates the remap table 1802 associated with the model number of the image capturing device 201 (step S1901). For example, the information processing apparatus 100 generates the remap table 1802 associated with the model number of the image capturing device 201 before the information processing system 200 is operated.

Next, the information processing apparatus 100 groups two or more image capturing devices 201 of the same model number based on the model number of each image capturing device 201 of a plurality of installed image capturing devices 201 (step S1902). For example, the information processing apparatus 100 groups two or more image capturing devices 201 of the same model number after the information processing system 200 is operated.

Next, the information processing apparatus 100 generates the remap table 1802 corresponding to each image capturing device 201 based on the remap table 1802 corresponding to the same model number of the two or more grouped image capturing devices 201 (step S1903). The information processing apparatus 100 performs remap processing on an image captured by each image capturing device 201 based on the generated remap table 1802 corresponding to the image capturing device 201 (step S1904).

Next, the information processing apparatus 100 determines whether the image capturing device 201 has been added or deleted (step S1905). When the image capturing device 201 has been added or deleted (step S1905: Yes), the information processing apparatus 100 returns to the processing of step S1902. On the other hand, when the image capturing device 201 has not been added and the image capturing device 201 has not been deleted (step S1905: No), the information processing apparatus 100 returns to the processing of step S1904.

### (Operation Example 4 of Information Processing Apparatus 100)

Next, operation example 4 of the information processing apparatus 100 will be described with reference to FIGS. 20 and 21.

As described above, there may be a case in which the distortion states of images captured by a plurality of image capturing devices 201 of the same model number are not the same. For example, there may be a situation in which the distortion state of an image changes due to uneven manufacturing of the image capturing device 201 or the like. For this reason, unique correction parameters are used instead of those common to the plurality of image capturing devices 201 of the same model number.

Operation example 4 is an operation example similar to operation example 3 corresponding to a case in which, in consideration of the above-described situation and the like, the FPGA 306 performs distortion correction on an image captured by each image capturing device 201 of two or more grouped image capturing devices 201.

For example, in operation example 4, a remap table unique to the image capturing device 201 is generable based on a reference table 2010 to be described later in FIG. 20 and a difference table 2020 to be described later in FIG. 20. First, an example of the reference table 2010 and the difference table 2020 in operation example 4 will be described with reference to FIG. 20.

FIG. 20 is an explanatory diagram illustrating an example of the reference table 2010 and the difference table 2020. In FIG. 20, there is a management table 2000. For example, the management table 2000 is realized by a storage area such as the memory 302 or the recording medium 305 of the information processing apparatus 100 illustrated in FIG. 3.

In FIG. 20, there are the reference table 2010 and the difference table 2020. For example, the reference table 2010 is realized by a storage area such as the memory 302 or the recording medium 305 of the information processing apparatus 100 illustrated in FIG. 3. For example, the difference table 2020 is realized by a storage area such as the memory 302 or the recording medium 305 of the information processing apparatus 100 illustrated in FIG. 3.

As illustrated in FIG. 20, the management table 2000 includes the fields of characteristic and difference table. In the management table 2000, management information is stored as a record 2000-c by setting information in each field for each characteristic. c is a given integer.

The characteristic of the image capturing device 201 is set in the field of characteristic. For example, the characteristic is the attribute of the image capturing device 201. For example, the attribute is the identification information unique to the image capturing device 201. For example, the characteristic may be the attribute of a lens of a camera included in the image capturing device 201. For example, the characteristic may be the attribute of an image captured by the image capturing device 201. Identification information of the difference table 2020 that makes generable a remap table corresponding to the above image capturing device 201 in combination with the reference table 2010 is set in the field of difference table.

As illustrated in FIG. 20, the reference table 2010 includes the fields of coordinates before correction and coordinates after correction. In the reference table 2010, reference information is stored as a record 2010-d by setting information in each field for each coordinate pair. d is a given integer. The storage contents of the reference table 2010 are similar to those of the remap table 910.

Coordinates before correction indicating the coordinates of a pixel included in an image before distortion correction are set in the field of coordinates before correction. Coordinates after correction representing the coordinates of a pixel included in an image after distortion correction corresponding to the above coordinates before correction are set in the field of coordinates after correction. For example, the coordinates after correction are identified by the average values of correction parameters. For example, the coordinates after correction are defined by the above formulae (3) and (4) using the average values of correction parameters.

As illustrated in FIG. 20, the difference table 2020 includes the field of difference. In the difference table 2020, difference information is stored as a record 2020-e by setting information in each field for each coordinate pair. e is a given integer.

Difference values for correcting the above coordinates after correction by being added to the above coordinates after correction are set in the field of difference. For example, difference values are defined by the difference between coordinates after correction and the above formulae (3) and (4) using the correction parameters of each image capturing device 201. Next, operation example 4 of the information processing apparatus 100 will be described with reference to FIG. 21.

FIG. 21 is an explanatory diagram illustrating operation example 4 of the information processing apparatus 100. Before the start of actual operation of the information processing system 200, the information processing apparatus 100 receives, from each image capturing device 201 of a plurality of image capturing devices 201 included in the information processing system 200, an image captured by the image capturing device 201 and accompanying data related to the image. For example, the accompanying data includes the attribute of the image capturing device 201 and correction parameters related to distortion correction.

Based on the received accompanying data, the information processing apparatus 100 groups two or more image capturing devices 201 for each of which it is determined that distortion correction may be indirectly performed on an image based on the same reference table 2010 among the plurality of image capturing devices 201. For example, the information processing apparatus 100 groups two or more image capturing devices 201 for each of which it is determined that distortion correction may be directly performed on an image based on any remap table 2102 that is generable based on the same reference table 2010. For example, the information processing apparatus 100 groups two or more image capturing devices 201 having the same model number.

In the example of FIG. 21, the information processing apparatus 100 groups two image capturing devices 201 having the same model number. The information processing apparatus 100 generates the reference table 2010 based on the correction parameters included in the accompanying data that has been received from each image capturing device 201 of the two grouped image capturing devices 201.

For example, the information processing apparatus 100 generates the reference table 2010 based on the average values of k₁ and k₂ among the correction parameters included in the accompanying data that has been received from each image capturing device 201 of the two grouped image capturing devices 201. For example, the information processing apparatus 100 identifies the correspondence relationship between the coordinates (u, v) and the coordinates (u′, v′) in accordance with the above formulae (7) and (8), and generates the reference table 2010.

Based on the correction parameters included in the accompanying data that has been received from each image capturing device 201 of the two grouped image capturing devices 201, the information processing apparatus 100 generates a remap table 2102 corresponding to the image capturing device 201. For example, the information processing apparatus 100 identifies the correspondence relationship between the coordinates (u, v) and the coordinates (u′, v′) in accordance with the above formulae (3) and (4), and generates the remap table 2102.

The information processing apparatus 100 calculates a difference between the remap table 2102 corresponding to each image capturing device 201 and the generated reference table 2010, and generates a difference table 2112. The difference table 2112 corresponds to the difference table 2020 illustrated in FIG. 20.

In the following description, the difference table 2112 corresponding to one image capturing device 201 of the two grouped image capturing devices 201 may be referred to as “difference table A 2112”. The difference table 2112 corresponding to the other image capturing device 201 may be referred to as “difference table B 2112”.

The information processing apparatus 100 may generate the management table 2000 illustrated in FIG. 20 (not illustrated) in which is stored the difference table 2112 generated in association with the identification information unique to each image capturing device 201 and corresponding to the image capturing device 201.

The information processing apparatus 100 stores the generated difference table 2112 in the DRAM of the memory 302 such that the FPGA 306 may access the DRAM. The information processing apparatus 100 stores parameters 2111 that make generable the reference table 2010 in the built-in memory of the FPGA 306. For example, the parameters 2111 include the average values of k₁ and k₂. Accordingly, the information processing apparatus 100 may make the reference table 2010 generable by the FPGA 306.

After the start of actual operation of the information processing system 200, the information processing apparatus 100 causes the FPGA 306 to refer to the difference table 2112 and perform distortion correction on an image captured by each image capturing device 201 of the two grouped image capturing devices 201. For each image capturing device 201 of the two grouped image capturing devices 201, the FPGA 306 includes a line buffer 2101 that stores each part of an image captured by the image capturing device 201.

The FPGA 306 receives an image captured by each image capturing device 201 of the two grouped image capturing devices 201, correction parameters, and the identification information unique to the image capturing device 201. Based on the received identification information unique to each image capturing device 201, the FPGA 306 reads the difference table 2112 corresponding to the image capturing device 201 from the DRAM of the memory 302.

The FPGA 306 performs reference value calculation processing and generates the reference table 2010 based on the parameters 2111. For each image capturing device 201 of the two grouped image capturing devices 201, the FPGA 306 combines the difference table 2112 corresponding to the image capturing device 201 and the reference table 2010, and generates the remap table 2102.

For the received image captured by each image capturing device 201, the FPGA 306 performs remap processing on the image based on the generated remap table 2102 corresponding to the image capturing device 201. The line buffers 2101 are referred to as “line buffer A 2101” and “line buffer B 2101” so as to be distinguishable from each other. The images captured by the two grouped image capturing devices 201 are referred to as “input image A” and “input image B” so as to be distinguishable.

For example, the FPGA 306 performs the remap processing A for each part read into the line buffer A 2101 while reading the input image A captured by one image capturing device 201 of the two grouped image capturing devices 201 into the line buffer A 2101. For example, the FPGA 306 outputs an output image A obtained by the remap processing A. For example, the FPGA 306 performs the remap processing B for each part read into the line buffer B 2101 while reading the input image B captured by the other image capturing device 201 of the two grouped image capturing devices 201 into the line buffer B 2101. For example, the FPGA 306 outputs an output image B obtained by the remap processing B.

Accordingly, the information processing apparatus 100 may suppress an increase in band usage for the DRAM of the memory 302 when performing distortion correction on an image captured by each image capturing device 201 of the two image capturing devices 201. For example, the amount of data of the difference table 2112 tends to be smaller than the amount of data of the remap table 2102.

For example, the amount of data of the remap table 2102 tends to increase according to the size of an image. For example, the value of coordinates of each axis in the remap table 2102 is represented by an integer part of 12 bits. On the other hand, for example, the difference value of each axis in the difference table 2112 may be represented by an integer part of 4 bits. For this reason, the information processing apparatus 100 may suppress an increase in band usage for the DRAM of the memory 302.

The information processing apparatus 100 may achieve reduction in the processing time taken to perform distortion correction on an image captured by each image capturing device 201 of the two image capturing devices 201. The information processing apparatus 100 may accurately reproduce the remap table 2102 suitable for each image capturing device 201 based on the difference table 2112. For this reason, the information processing apparatus 100 may enable distortion correction to be accurately performed on an image captured by each image capturing device 201.

Since the information processing apparatus 100 may group a plurality of image capturing devices 201 respectively corresponding to different remap tables 2102, an increase in band usage for the DRAM of the memory 302 may be easily suppressed.

Although a case has been described in which the information processing apparatus 100 groups two or more image capturing devices 201 having the same model number, this is not the only case. For example, there may be a case in which the information processing apparatus 100 groups two or more image capturing devices 201 having different model numbers. Since the remap table 2102 suitable for each image capturing device 201 is generable, the information processing apparatus 100 may also be applied in this case.

### Overall Processing Procedure in Operation Example 4

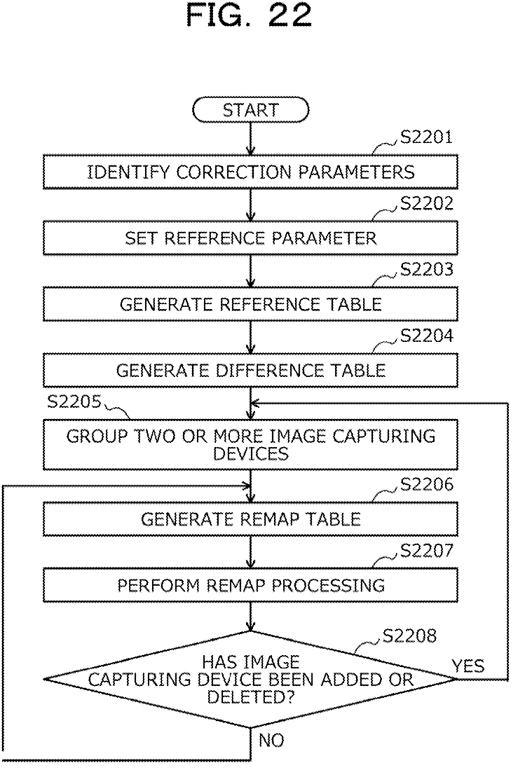

Next, an example of an overall processing procedure executed by the information processing apparatus 100 in operation example 4 will be described with reference to FIG. 22. For example, the overall processing is achieved by the CPU 301, a storage area such as the memory 302 or the recording medium 305, the network I/F 303, and the FPGA 306, which are illustrated in FIG. 3.

FIG. 22 is a flowchart illustrating an example of an overall processing procedure in operation example 4. In FIG. 22, the information processing apparatus 100 performs calibration of the image capturing device 201 to be installed in advance, and identifies correction parameters (step S2201).

Next, the information processing apparatus 100 sets, as reference parameters, the average values of the correction parameters identified for each of the image capturing devices 201 having the same model number (step S2202).

The information processing apparatus 100 generates the reference table 2010 associated with the same model number based on the reference parameters (step S2203). For example, the information processing apparatus 100 generates the reference table 2010 associated with the model number of the image capturing device 201 before the information processing system 200 is operated.

Next, the information processing apparatus 100 generates the difference table 2020 associated with each image capturing device 201 to be installed and representing the difference between the reference table 2010 and the remap table 2102 corresponding to the image capturing device 201 of the model number (step S2204). For example, the difference table 2020 is stored in the DRAM of the memory 302.

Next, the information processing apparatus 100 groups two or more image capturing devices 201 of the same model number based on the model number of each image capturing device 201 of a plurality of installed image capturing devices 201 (step S2205). For example, the information processing apparatus 100 groups two or more image capturing devices 201 of the same model number after the information processing system 200 is operated.

The information processing apparatus 100 reads the reference table 2010 corresponding to the same model number of the two or more grouped image capturing devices 201. Based on the read reference table 2010 and the difference table 2020 corresponding to each image capturing device 201, the information processing apparatus 100 generates the remap table 2102 corresponding to the image capturing device 201 (step S2206).

Next, the information processing apparatus 100 performs remap processing on an image captured by each image capturing device 201 based on the generated remap table 2102 corresponding to the image capturing device 201 (step S2207).

The information processing apparatus 100 determines whether the image capturing device 201 has been added or deleted (step S2208). When the image capturing device 201 has been added or deleted (step S2208: Yes), the information processing apparatus 100 returns to the processing of step S2205. On the other hand, when the image capturing device 201 has not been added and the image capturing device 201 has not been deleted (step S2208: No), the information processing apparatus 100 returns to the processing of step S2206.

As described above, the information processing apparatus 100 may identifiably store, in the storage unit 500, correction information that enables distortion correction to be performed on an image. The information processing apparatus 100 may group two or more imaging units for each of which it is determined that distortion correction may be performed on an image based on first correction information among a plurality of imaging units, based on the characteristic of each imaging unit of the plurality of imaging units. The information processing apparatus 100 may perform distortion correction on an image captured by each imaging unit of two or more grouped imaging units, based on the first correction information identified from the storage contents of the storage unit 500. Accordingly, the information processing apparatus 100 may suppress an increase in band usage for the storage unit 500.

The information processing apparatus 100 may group two or more imaging units based on the parameters acquired from each imaging unit of the plurality of imaging units, the parameters being related to an image captured by the imaging unit. Accordingly, the information processing apparatus 100 may appropriately and easily group two or more imaging units that may use correction information in common.

When the band usage of the storage unit 500 exceeds a threshold, the information processing apparatus 100 may generate second correction information obtained by estimating the first correction information, based on a part of the first correction information identified from the storage contents of the storage unit 500. The information processing apparatus 100 may perform distortion correction on an image captured by each imaging unit of the two or more grouped imaging units, based on the generated second correction information. Accordingly, the information processing apparatus 100 may achieve reduction in band usage for the storage unit 500.

The information processing apparatus 100 may group two or more imaging units for each of which it is determined that distortion correction may be performed on an image based on correction information that is similar to the first correction information among the plurality of imaging units. The information processing apparatus 100 may generate third correction information that is similar to the first correction information and that enables, for each imaging unit of the two or more grouped imaging units, distortion correction to be performed on an image captured by the imaging unit, based on the first correction information. For each imaging unit of the two or more grouped imaging units, the information processing apparatus 100 may perform distortion correction on an image captured by the imaging unit based on the generated third correction information. Accordingly, the information processing apparatus 100 may achieve an increase in the number of grouped imaging units, and may achieve reduction in band usage for the storage unit 500.

The information processing apparatus 100 may store difference information between each piece of correction information and reference correction information that is generable from specific parameters, so as to make identifiable each piece of correction information of a plurality of pieces of correction information that enables distortion correction to be performed on different images. The information processing apparatus 100 may group two or more imaging units for each of which it is determined that distortion correction may be performed on an image based on correction information included in the plurality of pieces of correction information among the plurality of imaging units. For each imaging unit, the information processing apparatus 100 may generate fourth correction information that enables distortion correction to be performed on an image captured by the imaging unit, based on the reference correction information and the difference information identified from the storage contents of the storage unit 500. For each imaging unit of the two or more grouped imaging units, the information processing apparatus 100 may perform distortion correction on an image captured by the imaging unit based on the generated fourth correction information. Accordingly, the information processing apparatus 100 may achieve an increase in the number of grouped imaging units, and may achieve reduction in band usage for the storage unit 500.

The information processing apparatus 100 may identify, as the first correction information, correction information corresponding to any imaging unit of the two or more grouped imaging units in the storage contents of the storage unit 500. Accordingly, the information processing apparatus 100 may enable distortion correction to be performed on an image.

The information processing apparatus 100 may refer to the storage contents of the storage unit 500 and identify the first correction information based on the attribute of at least any imaging unit of the two or more grouped imaging units. Accordingly, the information processing apparatus 100 may enable distortion correction to be performed on an image.

The information processing apparatus 100 may refer to the storage contents of the storage unit 500 and identify the first correction information based on the attribute information of an image captured by at least any imaging unit of the two or more grouped imaging units. Accordingly, the information processing apparatus 100 may enable distortion correction to be performed on an image.

The information processing apparatus 100 may generate the first correction information based on the characteristics of the two or more grouped imaging units and store the first correction information in the storage unit 500. Accordingly, the information processing apparatus 100 may update the storage contents of the storage unit 500 so as to enable distortion correction to be performed on an image.

The information processing apparatus 100 may perform at least distortion correction by using the FPGA 306 that may access the external storage unit 500. Accordingly, the information processing apparatus 100 may achieve reduction in the processing time taken to perform distortion correction on an image.

The information processing apparatus 100 may store, in the storage unit 500, difference information between each piece of correction information and reference correction information that is generable from specific parameters, so as to make identifiable each piece of correction information of a plurality of pieces of correction information that enables distortion correction to be performed on different images. The information processing apparatus 100 may group two or more imaging units for each of which it is determined that distortion correction may be performed on an image based on correction information included in the plurality of pieces of correction information among the plurality of imaging units. For each imaging unit, the information processing apparatus 100 may generate fourth correction information that enables distortion correction to be performed on an image captured by the imaging unit, based on the reference correction information and the difference information identified from the storage contents of the storage unit 500. For each imaging unit of the two or more grouped imaging units, the information processing apparatus 100 may perform distortion correction on an image captured by the imaging unit based on the generated fourth correction information. Accordingly, the information processing apparatus 100 may achieve an increase in the number of grouped imaging units, and may achieve reduction in band usage for the storage unit 500.

The correction processing method described in the present embodiment may be implemented by causing a computer, such as a PC or a workstation, to execute a program prepared in advance. The correction processing program described in the present embodiment is recorded on a computer-readable recording medium and is executed by being read from the recording medium by the computer. The recording medium is a hard disk, a flexible disk, a compact disc (CD)-ROM, a magneto-optical (MO) disk, a Digital Versatile Disc (DVD), or the like. The correction processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory configured to store correction information for performing distortion correction on an image; and
a processor coupled to the memory and configured to:
based on a characteristic of each imaging circuit of a plurality of imaging circuits that captures different images, group two or more imaging circuits for each of which determination is made that distortion correction is capable of being performed on an image based on the correction information among the plurality of imaging circuits; and
perform distortion correction on an image captured by each imaging circuit of the two or more imaging circuits that are grouped, based on the correction information stored in the memory.

2. The information processing apparatus according to claim 1,
wherein the processor
groups two or more imaging circuits based on parameters acquired from each imaging circuit of the plurality of imaging circuits, the parameters being related to an image captured by the imaging circuit.

3. The information processing apparatus according to claim 1,
wherein the processor
generates second correction information obtained by estimating the correction information based on a part of the correction information stored in the memory, when band usage of the memory exceeds a threshold, and
performs distortion correction on an image captured by each imaging circuit of the two or more imaging circuits that are grouped, based on the second correction information that is generated.

4. The information processing apparatus according to claim 1,
wherein the processor
groups two or more imaging circuits for each of which determination is made that distortion correction is capable of being performed on an image based on correction information that is similar to the correction information stored in the memory among the plurality of imaging circuits,
generates, for each imaging circuit of the two or more imaging circuits that are grouped, third correction information that is similar to the correction information for performing distortion correction on an image captured by the imaging circuit, based on the correction information stored in the memory, and
performs, for each imaging circuit of the two or more imaging circuits that are grouped, distortion correction on an image captured by the imaging circuit, based on the third correction information that is generated.

5. The information processing apparatus according to claim 1,
wherein the processor
stores difference information between each piece of correction information of a plurality of pieces of correction information for performing distortion correction on different images and reference correction information that is generable from specific parameters, the difference information making identifiable the each piece of correction information,
groups two or more imaging circuits for each of which determination is made that distortion correction is capable of being performed on an image based on correction information included in the plurality of pieces of correction information among the plurality of imaging circuits,
generates, for each imaging circuit of the two or more imaging circuits that are grouped, fourth correction information for performing distortion correction on an image captured by the imaging circuit among the plurality of pieces of correction information, based on the reference correction information generated from the specific parameters and the difference information stored in the memory, and
performs, for each imaging circuit of the two or more imaging circuits that are grouped, distortion correction on an image captured by the imaging circuit, based on the fourth correction information that is generated.

6. The information processing apparatus according to claim 1,
wherein the processor
identifies the correction information stored in the memory that corresponds to any imaging circuit of the two or more imaging circuits that are grouped, and
performs distortion correction on an image captured by each imaging circuit of the two or more imaging circuits that are grouped, based on the correction information stored in the memory that is identified.

7. The information processing apparatus according to claim 1,
wherein the processor
identifies the correction information stored in the memory based on attribute information of at least any imaging circuit of the two or more imaging circuits that are grouped, and
performs distortion correction on an image captured by each imaging circuit of the two or more imaging circuits that are grouped, based on the correction information stored in the memory that is identified.

8. The information processing apparatus according to claim 1,
wherein the processor
identifies the correction information stored in the memory based on attribute information of an image captured by at least any imaging circuit of the two or more imaging circuits that are grouped, and
performs distortion correction on an image captured by each imaging circuit of the two or more imaging circuits that are grouped, based on the correction information stored in the memory that is identified.

9. The information processing apparatus according to claim 1, wherein further included is a memory that generates, based on characteristics of the two or more i imaging circuits that are grouped, the correction information for performing distortion correction on an image captured by the each imaging circuit, and stores the correction information in the memory.

10. The information processing apparatus according to claim 1, wherein the processor performs at least the distortion correction by using a field-programmable gate array (FPGA) that is capable of accessing the memory that is external.

11. An information processing apparatus comprising:
a memory configured to store difference information between each piece of correction information of a plurality of pieces of correction information for performing distortion correction on different images and reference correction information that is generable from specific parameters, the difference information making identifiable the each piece of correction information; and
a processor configured to group two or more imaging circuits for each of which determination is made that distortion correction is capable of being performed on an image based on correction information included in the plurality of pieces of correction information among a plurality of imaging circuits that captures different images,
generates, for each imaging circuit of the two or more imaging circuits that are grouped, correction information for performing distortion correction on an image captured by the imaging circuit among the plurality of pieces of correction information, based on the reference correction information generated from the specific parameters and the difference information stored in the memory, and
performs, for each imaging circuit of the two or more imaging circuits that are grouped, distortion correction on an image captured by the imaging circuit, based on the correction information that is generated.

12. An information processing method comprising:
based on a characteristic of each imaging circuit of a plurality of imaging circuits that captures different images, grouping two or more imaging circuits for each of which determination is made that distortion correction is capable of being performed on an image based on correction information, which is stored in a memory, among the plurality of imaging circuits; and
performing distortion correction on an image captured by each imaging circuit of the two or more imaging circuits that are grouped, based on the correction information stored in the memory.
